(19) United States
(12) Patent Application Publication
(10) Pub. No.: US 2011/0146175 A1
(43) Pub. Date: Jun. 23, 2011

(54) IMAGED STONE, ROCK, BRICK AND WOOD POLYMERIC LANDSCAPING AND WALL VENEERING PRODUCTS

(76) Inventors: Paul J. FORSBERG, Windermere, FL (US); Robert J. RACE, Eagan, MN (US); John F. DOLAN, Golden Valley, MN (US); Craig S. WYLER, Papillion, NE (US); GARRY GEHRKE, JORDAN, MN (US)

(21) Appl. No.: 12/547,300

(22) Filed: Aug. 25, 2009

Related U.S. Application Data
(63) Continuation-in-part of application No. 11/872,812, filed on Oct. 16, 2007.
Application No. 11/872,812 is a continuation-in-part of application No. 11/463,816, filed on Aug. 10, 2006, now Pat. No. 7,866,923.
(60) Provisional application No. 60/829,925, filed on Oct. 18, 2006.
(60) Provisional application No. 60/953,040, filed on Jul. 31, 2007.
(60) Provisional application No. 61/091,579, filed on Aug. 25, 2008.

(51) Int. Cl. E04C 2/20; B44F 9/04; B44F 9/02; B28B 11/04; B44F 9/00

(52) U.S. Cl. 52/309.1; 428/15; 428/151; 425/94; 428/141

(57) ABSTRACT

The present invention relates to landscaping products (e.g. retaining wall building materials, landscaping stones/boulders, pavers . . . ) and wall veneering products that provide a replica image of a natural stone, rock, brick or wood surface. Such landscaping and veneering products are easily installable due to its lightweight characteristics and engagable design. The present invention further includes methods of use for such landscaping and veneering products and also includes systems for assembling such products to provide pleasing landscaping and wall veneering arrangements. The present invention also includes methods of manufacture of these imaged stone products, which ensures the natural appearance of stone, rock, brick or wood by imaging a natural surface, such as stone or a rock, preparing a mold from that image to mass produce a replica of that particular surface and applying a coating to the surface of the replica to provide the appearance and texture of the natural stone or rock.

### CROSS-REFERENCE TO RELATED APPLICATION

This application claims priority to and is a continuation-in-part application of U.S. patent application Ser. No. 11/872,812, filed on Oct. 16, 2007, which claims priority to U.S. Provisional Application Ser. No. 60/829,925, filed on Oct. 18, 2006, and U.S. Provisional Application No. 60/953,040 filed on Jul. 31, 2007 and is a continuation-in-part of U.S. patent application Ser. No. 11/463,816, filed on Aug. 10, 2006. This application also claims priority to U.S. Provisional Application Ser. No. 61/091,579, filed on Aug. 25, 2008. The contents of all previously mentioned applications are incorporated by reference herein.

### FIELD OF THE INVENTION

The present invention relates to landscaping products (e.g. retaining wall building materials, landscaping stones/boulders, pavers . . . ) and wall veneering products that provide a replica image of a natural stone, rock, brick or wood surface. Such landscaping and veneering products are easily installable due to its lightweight characteristics and engagable design. The present invention further includes methods of use for such landscaping and veneering products and also includes systems for assembling such products to provide pleasing landscaping and wall veneering arrangements. The present invention also includes methods of manufacture of these imaged stone products, which ensures the natural appearance of stone, rock, brick or wood by imaging a natural surface, such as stone or a rock, preparing a mold from that image to mass produce a replica of that particular surface and applying a coating to the surface of the replica to provide the appearance and texture of the natural stone or rock.

### BACKGROUND OF THE INVENTION

Even though the use of the actual natural materials (e.g. cut stone, rocks, boulders, brick or wood) is common in the construction and landscaping industries, such products have produced challenges that have caused problems related to transportation and installation. For example, the utilization of natural stone, concrete, boulders, brick or wood can be cumbersome during transportation and installation of such products due to their heavy weight and, when used as wall coverings, the difficulties in easily attaching such products to each other or to the surface of a substrate such as a wall or panel. Furthermore, stone (natural or cultured), rock, concrete and wood products often discolor, stain or degrade over time, thereby damaging their aesthetic appearance and ultimately requiring their replacement.

The landscaping/construction industry and home improvement product manufacturers have found difficulties in manufacturing products utilizing materials such as plastic, fiberglass, ceramics and the like that simulate cut stone, rock and boulders. Such products have not been able to adequately capture the desired look found in their natural counterparts and in many of these products, have been less that durable. For example, such products often do not have the proper combination of texture, relief and color that would lead an observer to believe it was the natural product rather than a poor simulation. The industry still searches for a landscaping, construction and/or resurfacing product that is lightweight, easily installable, consistently durable, provides stunning natural aesthetics and maintains its natural appearance for long periods of time.

### SUMMARY OF THE INVENTION

Embodiments of the present invention relate to polymeric or composite landscaping products or wall surface veneering products and the methods of use and manufacture for such products. The landscaping and veneering products of the present invention are generally produced with one or more materials (e.g. thermoplastics, thermosets, fiberglass, ceramics . . . ) that are resistant to damage and wear caused by the environment, such as sunlight, water, pest infestation and staining from dirt or other organic materials. In various embodiments of the present invention, the utilization of polymers (e.g. high density polyethylene, polypropylene and the like), that are processed using high pressure injection molding, compression molding, structural foam and/or other foamed polymer techniques (e.g. implementation of chemical foaming agents) produce landscaping and wall veneering products that have desirable textures and relief, but still provide incredibly robust and sturdy structural characteristics. Moreover, in various embodiments, the use of structural foam and/or foamed polymer products that are coated using the processes and techniques described herein provide the desired texture and color of the natural product, such as stone, rock or boulders. The landscaping and veneering products of the present invention are generally light weight and provide a beneficial alternative to other landscaping or wall coverings, such as natural or cultured stone, brick, wood, boulders, rock and the like.

### BRIEF DESCRIPTION OF THE DRAWINGS

FIG. 1 is a front perspective view of one embodiment of a deterioration resistant mass confinement cell of the present invention that includes a frame, load cell and fascia.

FIG. 2A is a front perspective view of an embodiment of a frame of the deterioration resistant mass confinement cell of FIG. 1.

FIG. 2B is a back perspective view of an embodiment of a frame of the deterioration resistant mass confinement cell of FIG. 1.

FIG. 2C-E are top, front and side views of an embodiment of a frame of the deterioration resistant mass confinement cell of FIG. 1.

FIG. 3 is a perspective view of one embodiment of the frame of the deterioration resistant mass confinement cell of FIG. 1 positioned in a flat configuration.

FIG. 4A is a front perspective view of an embodiment of a load cell of the deterioration resistant mass confinement cell of FIG. 1.

FIG. 4B is a back perspective view of an embodiment of a load cell of the deterioration resistant mass confinement cell of FIG. 1.

FIG. 5A is a front view of one embodiment of a fascia that may be utilized with the deterioration resistant cells of the present invention.

FIG. 5B is a back view of one embodiment of a fascia that may be utilized with the deterioration resistant cells of the present invention.

FIG. 6A is a front view of one embodiment of a fascia that may be utilized with the deterioration resistant cells of the present invention.

FIG. 6B is a back view of one embodiment of a fascia that may be utilized with the deterioration resistant cells of the present invention.

FIG. 7A is a front view of one embodiment of a fascia that may be utilized with the deterioration resistant cells of the present invention.

FIG. 7B is a back view of one embodiment of a fascia that may be utilized with the deterioration resistant cells of the present invention.

FIG. 8 is an exploded view of one embodiment of a deterioration resistant mass confinement cell including a frame, enclosing bar and fascia.

FIG. 8A is a front perspective view of an embodiment of the frame adjoined to the enclosing bar of the deterioration resistant mass confinement cell of FIG. 8 in a folded assembly position.

FIG. 8B is a front view of one embodiment of a fascia that may be utilized with the deterioration resistant cells of the present invention, such as the cell of FIG. 8.

FIG. 9A is a front view of one embodiment of an end cap that may be utilized with the deterioration resistant cells of the present invention.

FIG. 9B is a back view of one embodiment of an end cap that may be utilized with the deterioration resistant cells of the present invention.

FIGS. 10A-D are front perspective, top, side and front views of one embodiment of a 90° corner cell of the present invention.

FIG. 11 is a front perspective view of one embodiment of a deterioration resistant mass confinement cell of the present invention that includes a frame, load cell, fascia and end caps.

FIG. 12 is an exploded view of the deterioration resistant mass confinement cell of FIG. 11.

FIG. 12A is an exploded view of one embodiment of a deterioration resistant mass confinement cell of the present invention that includes a frame, load cell, fascia and top cap.

FIG. 13 is a front perspective view of the deterioration resistant mass confinement cell of FIG. 1 that further includes an adjoined geogrid.

FIG. 13A is a front perspective view of the deterioration resistant mass confinement cell of FIG. 11 that further includes an adjoined geogrid.

FIG. 14 depicts a top view of a deterioration resistant retaining wall row that includes a plurality of cells that have interlocking pegs and hinges.

FIG. 14A depicts a front perspective view of two mass confinement cells that are laterally adjoined with interlocking pegs and hinges.

FIG. 14B-C depicts sectional views of a deterioration resistant retaining wall row that includes an interlocking peg and interlocking hinge, respectively.

FIG. 15 depicts an exploded perspective view of an embodiment of an interlocking mechanism used with the deterioration resistant mass confinement cell that includes pegs and hinges.

FIG. 16 depicts a perspective view of an embodiment of an interlocking mechanism use with the deterioration resistant mass confinement cell of the present invention that is a clipping device.

FIG. 17 depicts a perspective view of an embodiment of an interlocking mechanism use with the deterioration resistant mass confinement cell of the present invention of the present invention that is an integral hook.

FIG. 18 is a front perspective view of one embodiment of a front surface of a polymeric veneering product of the present invention.

FIG. 19 is a perspective view of one embodiment of a back surface of a polymeric veneering product of the present invention.

FIG. 20A is a front view of one embodiment of a front surface of a polymeric veneering product of the present invention that is in a T-unit configuration.

FIG. 20B is a front view of one embodiment of a front surface of a polymeric veneering product of the present invention that is in a Z-unit configuration.

FIG. 20C is a front view of a wall including at least four Z-unit polymeric veneering product embodiments of the present invention.

FIG. 21A is a front perspective view of one embodiment of a front surface of a polymeric veneering product of the present invention that is in a T-unit configuration and includes an adhesive fastening device.

FIG. 21B is a front perspective view of one embodiment of a front surface of a polymeric veneering product of the present invention that is in a Z-unit configuration and includes an adhesive fastening device.

FIG. 21C is a back perspective view of one embodiment of a front surface of a polymeric veneering product of the present invention that is in a T-unit configuration.

FIG. 21D is a back perspective view of one embodiment of a front surface of a polymeric veneering product of the present invention that is in a Z-unit configuration.

FIG. 22A is a front view of one embodiment of a polymeric veneering product of the present invention having a Z-unit configuration and including a tongue and groove fastening system.

FIG. 22B is a side view of one embodiment of a polymeric veneering product of the present invention having a Z-unit configuration and including a tongue and groove fastening system.

FIGS. 23A-E are various views of one embodiment of a corner wall cover of a polymeric wall covering product of the present invention.

FIGS. 24A-E are views of a concrete segmental retaining wall block and polymeric veneering product covering.

FIGS. 25A-C are views of a concrete segmental retaining wall block design that is adapted to receive a polymeric veneering product covering.

FIG. 26 is a view of one embodiment of a chain on edge paint line that may be used to paint the landscaping and wall covering products of the present invention.

FIG. 27 is a view of one embodiment of a first paint booth that may be used to apply the base coating on the substrates of the landscaping and wall covering products of the present invention.

FIG. 28 is a view of one embodiment of a drying mechanism for partially drying the substrates following application of the base coating to the substrates of the present invention.

FIG. 29 is a view of one embodiment of a second paint booth that may be used to apply the secondary coating(s) on the substrates of the landscaping and wall covering products of the present invention.

FIG. 30 is a view of one embodiment of a paint movement device that may be used to maneuver or move the secondary coating(s) on the substrates of the landscaping and wall covering products of the present invention.

FIG. 31 is a view of one embodiment of a paint movement device in operation that may be used to maneuver or move the secondary coating(s) on the substrates of the landscaping and wall covering products of the present invention.

FIG. 32 is a view of one embodiment of a texture applicator that may be used to apply texture to the substrates of the landscaping and wall covering products of the present invention.

FIG. 33 is a view of one embodiment of a convection oven that may be used to cure the coatings applied to the substrates of the landscaping and wall covering products of the present invention.

### DETAILED DESCRIPTION OF THE INVENTION

The embodiments of the present invention described below are not intended to be exhaustive or to limit the invention to the precise forms disclosed in the following detailed description. Rather, the embodiments are chosen and described so that others skilled in the art can appreciate and understand the principles and practices of the present invention. Hence, the methods and processes described in each of the embodiments disclosed below may be applicable to other embodiments. For example, the techniques described below to image, texture, paint and or coat a substrate to produce a stone, rock or boulder appearance may be utilized in any embodiment related to retaining wall block/mass confinement cell technology, pavers, boulders, wall veneering or any other landscaping or wall covering product wherein the appearance of natural stone, rock or boulders is desired.

In various embodiments of the present invention, deterioration resistant blocks or mass confinement cells may be imaged, textured and painted to provide the appearance of cut or quarried stone or rock. Examples of such blocks or mass confinement cells may be found in U.S. Pat. Nos. 6,571,154, 6,817,154 and 7,198,435, and U.S. patent application Ser. Nos. 11/463,816 and 11/463,820, the entire contents of which are incorporated by reference herein.

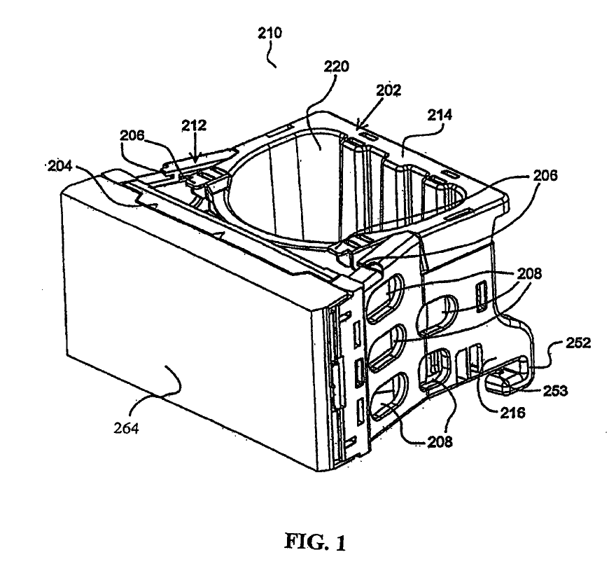

FIG. 1 depicts one example of a deterioration resistant mass confinement cell 210 comprising a frame 212 operably adjoined to a load cell 202 and an aesthetic fascia 254. The frame 212 of this embodiment generally includes a front panel 224 operably adjoined to one or more side panels 216; in this example two side panels 216. The load cell 202 may include a back panel 214 and secures to one or more of the side panels 216 to join the frame 212 to the load cell 202, thereby forming a continuous flow chamber 220 in the mass confinement cell 210. The continuous flow chamber 220 is generally positioned within the frame 212 and load cell 202.

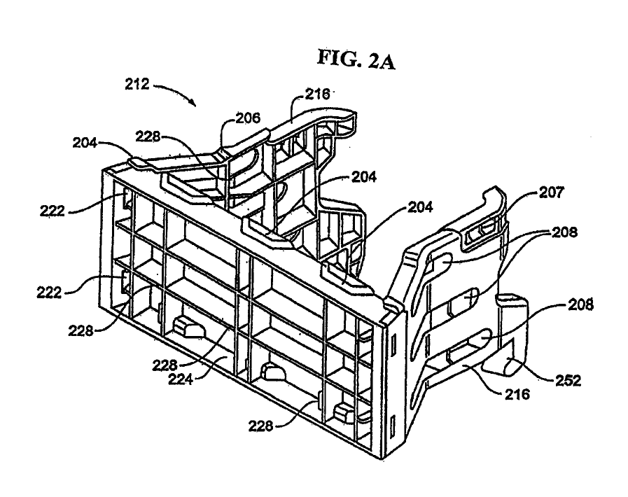

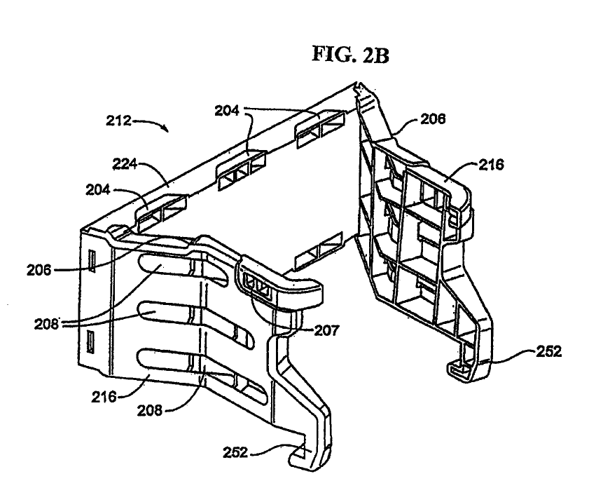

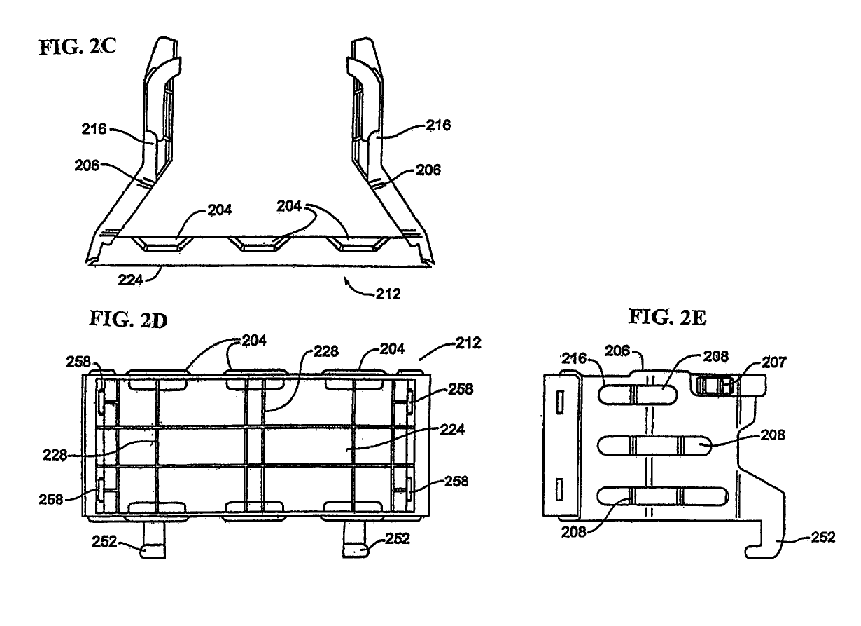

FIGS. 2 A-E depict one embodiment of a frame 212 in a folded or assembly position, thereby being prepared for mass confinement cell 210 assembly. As previously suggested, the frame 212 generally includes a front panel 224 operable adjoined to one or more side panels 216 by one or more securing mechanisms 222 (e.g. living hinges, clasps, snaps, pegs and pins).

Similar to the embodiments depicted in the paragraphs above, the mass confinement cells 210 of this embodiment include no top panel or a partial top panel and no bottom panel or a partial bottom panel. When a plurality of confinement cells 210 are positioned in proximity to each other in a wall structure, the open top and bottom allows for the flow and/or commingling of fill material from one confinement cell to adjacent confinement cells above and/or below through the continuous flow chambers 220.

In various embodiments of the present invention, the front panel 224 of the confinement cell 210 may be flat, rounded, beveled and/or textured by molding or by a secondary fabrication process to provide the desired earthen appearance and/or design. However, in other embodiments a fascia 254, as depicted in FIG. 1, is secured to the front panel 224 to provide the desired appearance. It is noted that the front panel 224 or fascia 254 may also be beveled, rounded, substantially flat or include positions of relief/texture to provide a more natural earthen appearance or desirable design.

As depicted in FIGS. 2A-E, the front panel 224 and side panels 216 of the frame 212 of this embodiment may include one or more ribs 228 on its front or back side to provide support and stability to the front panel 224 and side panels 216. As previously mentioned, the front panel 224 and side panels 216 further include at least part of one or more securing mechanisms 222. As will be explained further below, the front panel 224 or fascia 254 generally will display an earthen appearance or other desirable design, such as cut stone or rock, that may be molded into the front or exposed surface and/or may be fabricated and/or applied to the surface.

The front panel 224 may further include one or more load bearing members 204. These load bearing members 204 are configured to take pressure off the fascia 254 when a wall is assembled, thereby allowing for greater ease in removal and replacement when desired. The front panel 224 or fascia 254 may further include one or more side flaps (not shown) positioned on the outer edges of the front panel 224 or fascia 254. The side flaps may be flexible, textured and colored to hide the gaps between the various cells 210 placed in a wall and to assist in the reduction of fine fill material moving through the face of the wall.

In various embodiments of the present invention, as depicted in FIGS. 2 A-E, the side panels 216 further include one or more grid fasteners 206, wherein geogrid can thread over and secure when utilized between rows of confinement cells 210. In other embodiments, the grid fastener 206 may include an overhanging portion, as depicted in FIG. 1, that the grid can slide under, thereby inhibiting vertical movement of the grid once in position. The side panels 216 may further include lightening apertures 208. Such apertures 208 provide structure by allowing the fill material to flow through the apertures, thereby further locking the frame into the aggregate and corresponding slope. The apertures 208 further allow for reduction of resin and thereby make the product more light-weight and cost efficient. The lightening apertures 208 may further be utilized to adjoin side caps and other accessories desired to complete a wall.

The side panels 216 may further include one or more anchoring devices that may be utilized to position each cell 210 when assembling a wall and may also function to reduce or prevent overturn of the cells upon filling and compacting of fill material. One embodiment of the anchoring devices, as depict in FIGS. 1 and 2 A-E, are in the form of peg extensions 252. In this embodiment, the peg extensions 252 are designed to insert under and hook an anchoring ridge 262 or in an anchoring aperture positioned on the two load cells 202 located below in a wall, revetment or earth retention system. In alternative embodiments, the peg extensions may be positioned on top of the frame or cell to engage a ridge or slot on the mass confinement cells positioned above. Additionally, the peg extensions 252 may include a knob 253 as depicted in FIG. 1 or notch (not shown) that can secure the ridge position and restrict back and forth movement of the mass confinement 210.

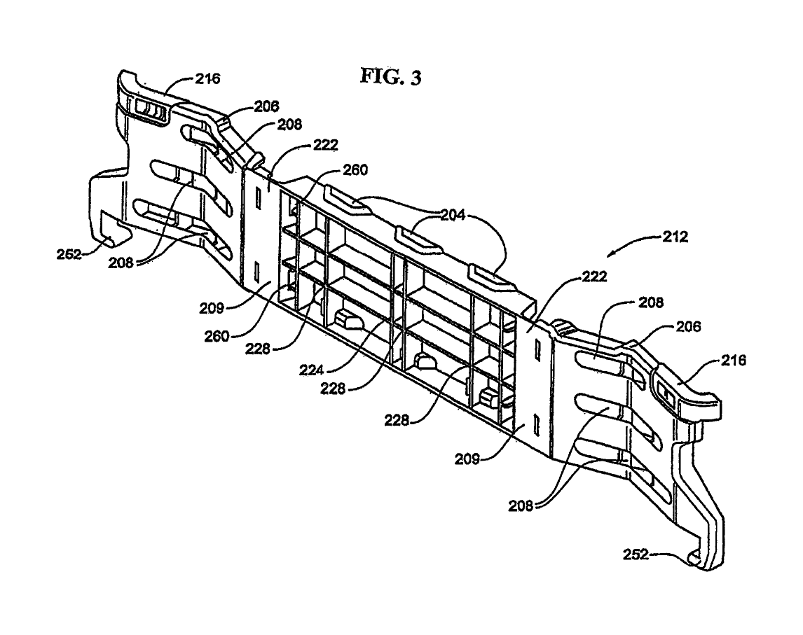

The frame 212 of this embodiment may also be transported and stored in a flat configuration. FIG. 3 depicts an embodiment of the frame 212 that is positioned in a flat configuration. In such embodiments, one or more of the side panels 216 are adjoined to the front panel 224 with one or more securing mechanisms 222. In this embodiment, the side panels 216 are adjoined to the front panel 224 with living hinges 209 and retention snaps. The living hinges 209 generally comprise a thin flexible material, such as plastic (e.g. HDPE, LDPE, polypropylene), that can bend into position without breaking when folding the frame 212 into assembly position to secure the load cell 204. Other securing members may be utilized to secure the panels of the frame (e.g. peg and sockets and mechanical hinges). It is noted that in other embodiments, the frame may be reversed, wherein the side panels are adjoined to a back panel of the confinement cell. Another embodiment may include a separate front panel or a securing mechanism to attach a fascia to the ends of the side panels or to the front of the load cell if it was desired to reverse the configuration of the confinement cell.

As previously mentioned, various embodiments of the frame 212 depicted in previously described FIGS. include one or more securing mechanisms 222 that secure the side panels 216 to the front panel 224 and/or back panel (not shown) when folded into assembly position. The securing mechanisms 222, in the embodiment depicted in FIGS. 2D and 3, include snaps 258 that are attached to the side panels 216 and engage and lock the front panel 224 into assembly position by passing the snaps 258 through snap apertures 260 located on the front panel 224. alternatively, a set of snaps (not shown) of opposite orientation may be adjoined to the front panel 224 and utilized to engage and hook the snaps positioned on the side panels 216. Other securing mechanisms 222 may be utilized in these embodiments, some of which are identified within.

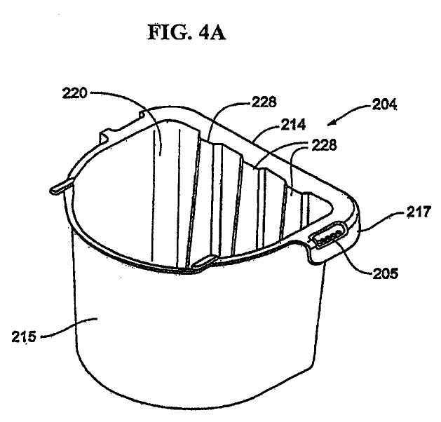

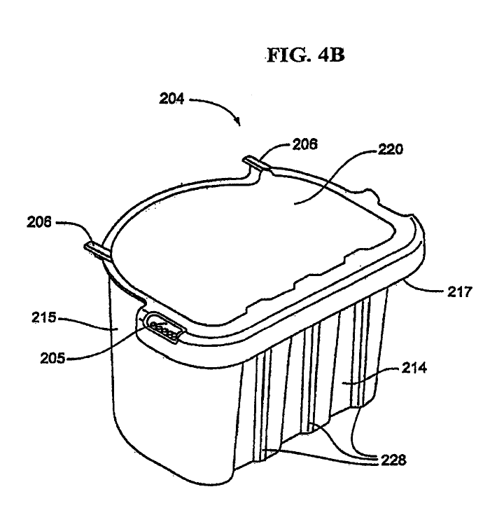

FIGS. 4A and 4B depict one embodiment of a load cell 204 that may be secured to the frame 212 by one or more load cell fasteners 205. Generally, the load cell 204 is a cylinder that when attached to the frame 212 forms at least a portion if not all of the continuous chamber 220 of the mass confinement cell 210. In this application a cylinder may comprise a cylinder that includes a circular or elliptical structure and may also include a structure that has one or more substantially straight sides and one or more rounded sides. Additionally, in other embodiments, the load cell 204 may comprise straight edges that round into a cylinder or elliptical configuration when filled. In the embodiments of FIGS. 4A and 4B the load cell 204 includes a substantially straight back panel 214 integrally adjoined to a rounded front section 215. The back panel 214 of the load cell 204 further includes ribs 228 that may be position on the front and/or back of the back panel 214 to provide additional stability. The load cell 204 may further include an anchoring ridge 217 or aperture (not shown) that may be utilized to accept the anchoring devices (e.g. peg extensions) for confinement cell 210 positioning and overturn prevention or reduction.

The load cell fasteners 205 may be any fastening device or material that securely adjoins the load cell 204 to the frame 212. In one embodiment, as depicted in FIGS. 4A and 4B the load cell fastener 205 is one or more projections that extend inward from the outer edge of the anchoring ridge 217. In operation, the load cell 204 is inserted over and into the frame 212 so that the load cell fastener 205 engages with a load cell aperture 207 or ridge on the side panels 216 of the frame 212. In other embodiments there may include two or more load cell fasteners 205 or load cell apertures 207 that may be utilized as set-back devices when positioning the confinement cells 210 in the wall structure. For example, a load cell fastener 205 or load cell apertures 207 may be positioned in front of a second load cell fastener 205 or load cell apertures 207 on the load cell 204 or side panels 216 to provide a set back of the confinement cells at a range of approximately 1 mm to 20 cm (e.g. 3 mm or 1.25 cm). Set back positions generally allow for a wall to be constructed in a vertical configuration or angled back into the slope. The set back positions of the load cell fasteners may be at any distance desired to provide the desired wall angle. Another alternative to multiple set-back positions would be to manufacture separate load cells 204 with different attachment points for set back rather than having multiple fasteners positioned on the load cells 204 and/or side panels 216.

The load cell 204 may further include one or more grid fasteners 206 for securing and positioning geogrid when it is utilized in a wall structure. The grid fastener 206 is configured to be inserted in an aperture of the geogrid and positioned over the geogrid at connection so that the grid does not move in a vertical direction once it is applied.

Additionally, in other embodiments, the load cell 204 may be split in two or more sections, wherein one section nests with the other section. The two nested sections allows for the compression of the sections together to make a smaller load cell that may be utilized when secured to a cut frame for partial confinement cells. In such embodiments, the two sections would further include a fastening device to fixedly secure the two sections together when the proper size is achieved, thereby preventing movement of the two sections of the load cell.

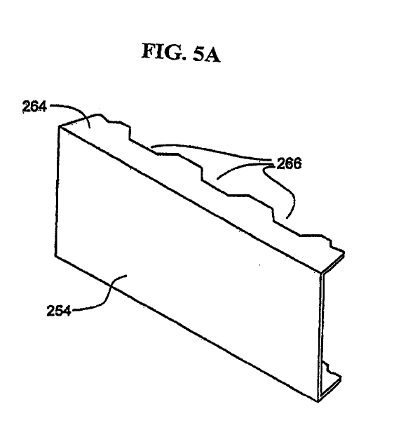

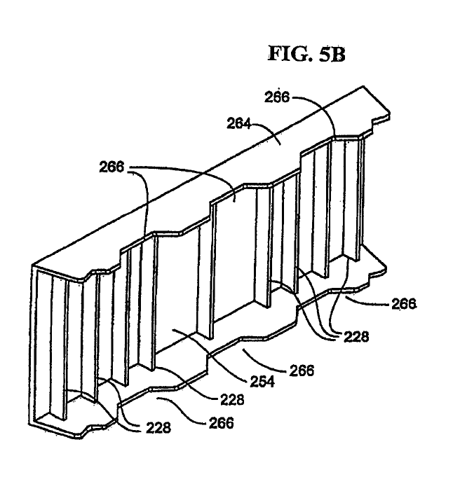

Various embodiments of the present invention may also include a fascia with the desired aesthetic appearance, rather than having the aesthetic appearance (e.g. texture and color) molded into the front face of the front panel 212. FIGS. 5A and 5B depict a front and back view of one embodiment of a fascia 254 that may be utilized with the confinement cells of the FIGS. described herein. Further explanation of fascia design and manufacture will be discussed below. The fascia 254 in various embodiments of the present invention may include a plurality of ribs 228 to add stability and structure to the fascia 254. It is noted that the top panel of the fascia 264 may include one or more indentations 266 to accommodate and alternate between the load bearing members 204 upon administering the fascia 254 to the front panel 224.

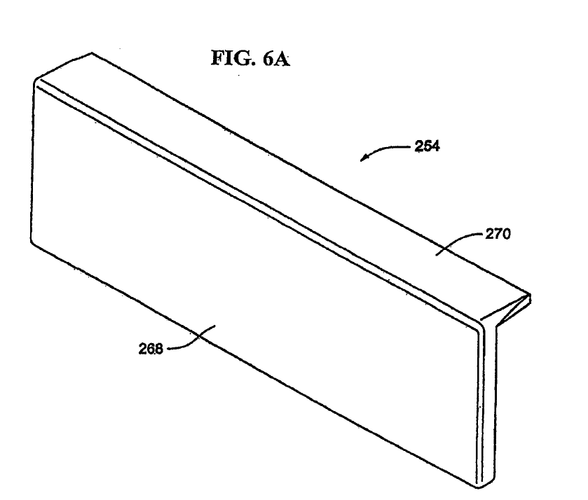

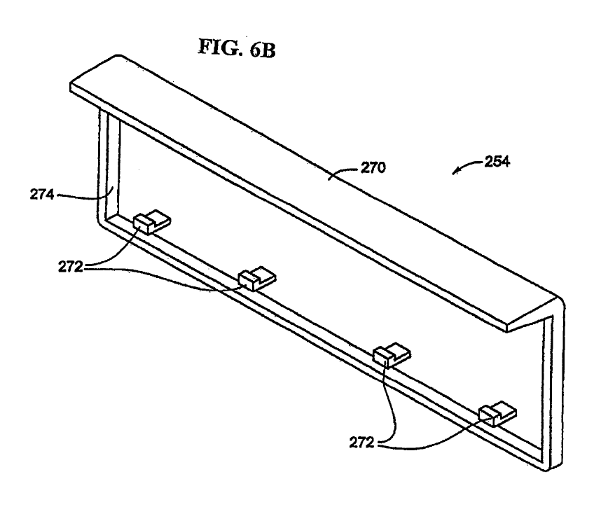

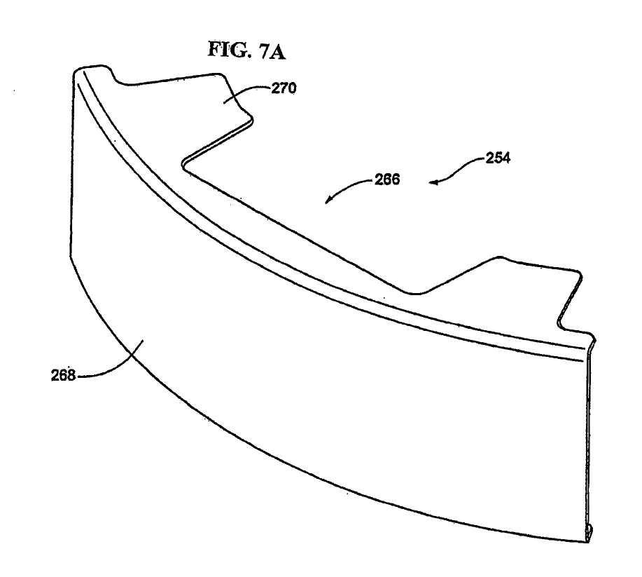

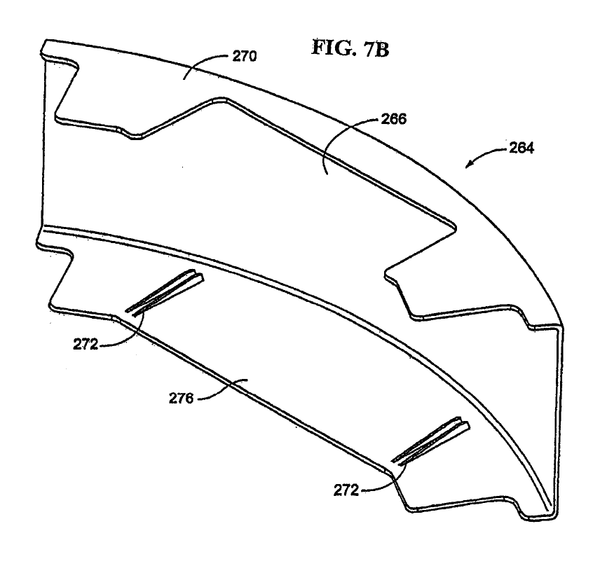

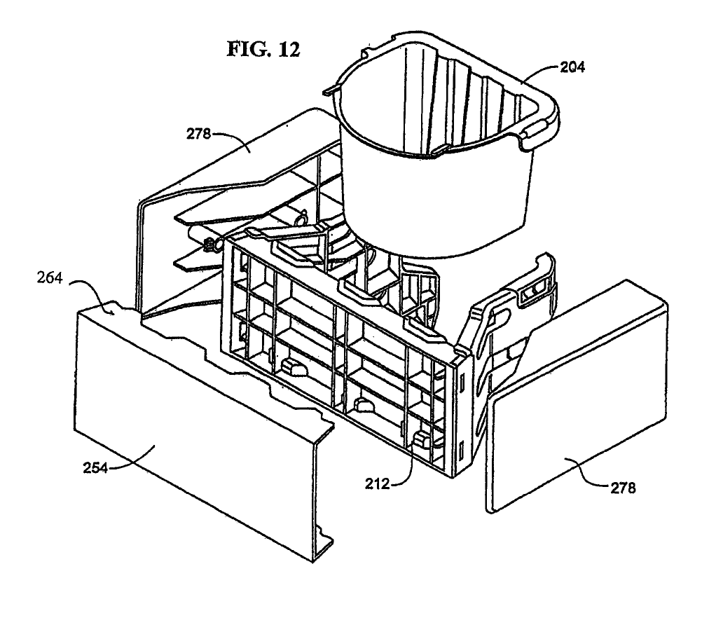

FIGS. 6A and 6B depict another embodiment of a fascia 254 that may be utilized with any embodiment of the present invention. Generally, the fascia 254 includes a front panel 268, a partial top panel 270 and one or more fascia fasteners 272. The fascia fasteners 272 may be any type of fastening device. In various embodiments the fascia fasteners 272 may be in the forms of clasps or snaps, as depicted in FIG. 6B, that can pass through a snap aperture, such as the snap apertures 273 depicted in FIG. 12. The fascia 254 may also optionally include wrap around sides 274, that wrap around the side panels and bottom panel upon assembly. Each of these panels may be textured and include color and/or other additives (e.g. U.V. inhibitor) to provide an earthen appearance, crystalline appearance or any other aesthetic design. In various embodiments of the present invention, a fascia 254 has an integral color that is present throughout the entire fascia. The integral color is usually greater than a 50% color match to the coated surface of the fascia. Such integral color allows for scratching and chipping of the surface, while still providing a natural stone or rock appearance. Additionally, such fascia may be prepared utilizing any of the techniques discussed below or those known in the art for forming the desired appearance. FIGS. 7A and 7B depict another embodiment of a fascia 254 of the present invention, wherein the fascia 254 also includes a partial bottom panel 276. In all of the embodiments of the present invention that include a fascia 254, the fascia 254 may be permanently fixed to the frame 212 or may be removable so as to be replaced when damaged or a change is desired.

In various embodiments of the mass confinement cells 210 and wall coverings of the present invention, the surface visible to the observer, such as the front panel 224 or fascia 254 of the mass confinement cell 210 will generally include a molded and/or fabricated texture and/or pattern in the deterioration resistant material. In various embodiments of the present invention the exposed surface of the landscaping product or wall covering, such as the front panel 224 or fascia 254, will have a natural earthen appearance simulating the texture and color of natural earthen surfaces. For example in some embodiments, the exposed surface of the front panel 224 or the surface of the fascia 254 may be textured and colored to have the appearance of rock, natural stone, sand, soil, clay, wood, trees and foliage, water, or any other natural earthen appearance. In other embodiments, the front panel 224 or fascia 254 will have a crystalline appearance or will have another aesthetically appealing design. Additionally, in other embodiments, the exposed surface of the landscaping product, such as the front panel 224 or fascia 254, may further include one or more designs (e.g. symbols, company names, logos, images) that may be positioned in the natural earthen appearance texture and color, crystalline texture and color or other design (e.g. a company logo embedded in a stone color and texture). Also, in other embodiments of the present invention, the front panel 224 or fascia 254 may further include a design, such as the appearance of multiple bricks, stones, or rocks. This allows for the installation of larger mass confinement cells (e.g. mega-cells) in a wall that appears to include a multitude of bricks, stones, blocks, timbers and the like.

In various embodiments of the present invention the texture and/or front surface of the front panel 224, 324 or fascia 254, 354 or the wall covering is produced by imaging an actual natural surface, such as natural stone, rock, brick or wood and producing a mold that mimics that particular image. In various embodiments of the present invention the front panel or other visible surface is produced by imaging an actual natural surface, such as natural stone, rock, brick or wood. The imaging of the natural surface can be performed by processes such as cast imaging of the natural surface or by digital scanning the natural surface. When cast imaging the natural surface a mirror image of the surface can be produced by providing a casting material, such as silicone, ceramics or fine sand, and casting it over and/or around the natural surface. Once the casting material sets or has formed a mirror image of the natural surface the object casted is removed from the newly formed mold of the natural surface and an opposite image or negative of the natural surface has been produced. Next the negative image can be cast again with a solidifying material to produce the positive image of the natural surface. Such a process produces a casting that captures the texture and relief of the natural surface. Once the casted mirror images (i.e. positive and negative) are produced, a mold and/or a mold insert manufactured from a suitable mold material, such as aluminum, steel or a ceramic, can be produced for mass manufacture by administering the mold material to the positive and/or negative casting to form the production mold. In various embodiments of the present invention, a very fine sand or ceramic is used to provide a detailed negative and/or positive image thereby providing the desired detail found in the natural surface which then can be transferred to a more durable steel or aluminum production mold for mass manufacture of panels having one or more natural surface images. Cast imaging of the natural surface may be performed by a cast foundry. Foundries that may be used to prepare such castings include but are not limited to Arrow Pattern and Foundry Company, 9725 South Industrial Drive, Bridgeview Ill. and WK Industries, 6120 Millett Ave., Sterling Heights, Mich.

Alternatively, a mold may be prepared by digitally scanning the natural surface, such that the surface of a stone, rock, brick or piece of wood. Once scanned, a mold can be produced from a suitable mold material for mass manufacture of the front panels or fascias having a front surface supporting the scanned image.

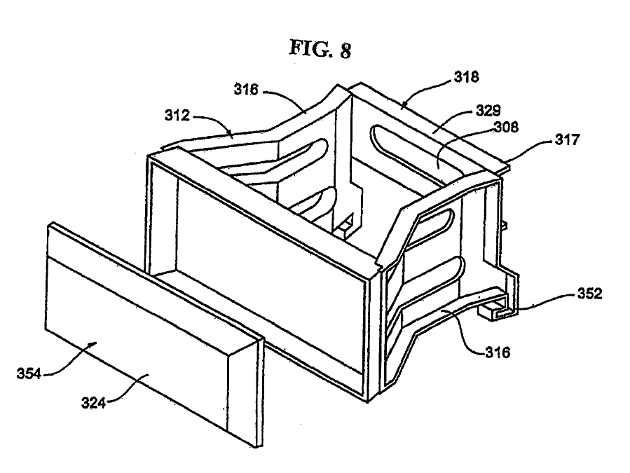

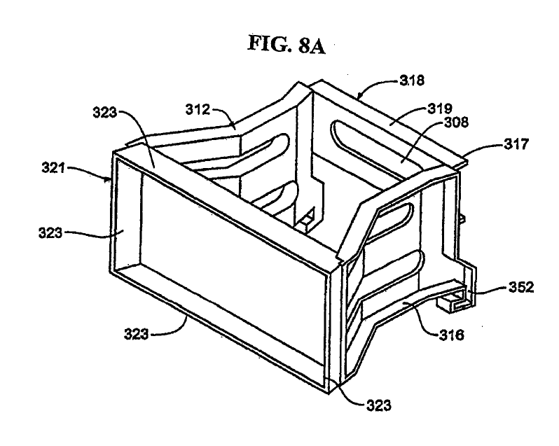

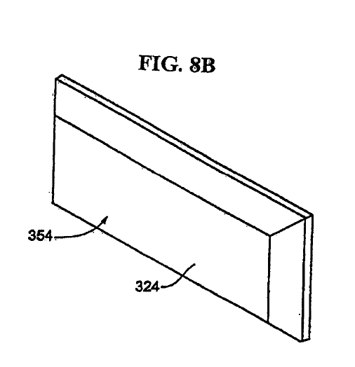

FIG. 8 depicts another embodiment of the mass confinement cell 310 of the present invention wherein the enclosing member 318 includes one or more enclosing bars 319 that are adjoined to the side panels 316 of the frame 312 to form the chamber 320. FIG. 8A depicts one embodiment of the frame 312 and enclosing member 318 wherein the enclosing bars 319 of the enclosing member 318 further include an anchoring ridge 317 for setting and securing the setting extensions 352 of each of the cells positioned above. The enclosing bars 319 may further include a lightening aperture 308 positioned in the interior of a single bar 319 or the enclosing member 318 may comprise two or more bars 319 (not shown) wherein a gap is present between the two or more bars. It is noted that the lightening aperture 308 may also be used as the anchoring ridge for setting and securing the setting extensions 352. The enclosing member 318 of the embodiment of FIG. 8 may be adjoined to the frame 312 with one or more securing mechanisms that adequately secures the member 318 to the frame 312. For example the enclosing member 318 may be adjoined to the frame 312 by one or more snaps positioned on the enclosing member 318 engaging one or more snap apertures or mirror image engaging snaps positioned on the frame 318. A similar snap and opposing snap or snap aperture securing mechanism is depicted in FIGS. 2A and 3. It is noted that the embodiment of FIG. 8 may also be designed in smaller sizes to accommodate partial units, such as half cells or one-third cells.

The mass confinement cell embodiment depicted in FIG. 8 further includes a fascia 354 as shown in 8B. The fascia 354 may include a front panel 324 having an earthen texture and color (e.g. stone, wood, rock) or any other aesthetic design molded, fabricated or applied to the visible surface. It is noted that in other embodiments of the present invention the front panel having an earthen texture and color or other aesthetic design may be integral with the frame rather than part of an attachable fascia. In various embodiments, the fascia may overlap the frame as depicted in the FIGS above or may nest within a fascia frame 321 as depicted in FIG. 8. As depicted in FIG. 8A the fascia frame 321 includes a ridge 323 that surrounds a nested fascia 354 and functions similar to a picture frame. The fascia frame 321 may be any color and in some embodiments may have the color and appearance of grout. In other embodiments of the present invention, a confinement cell may include more than one fascia frame wherein multiple fascias may be nested in each separate frame. In various embodiments the multiple fascia frames may provide the appearance of multiple stones positioned in a single mass confinement cell.

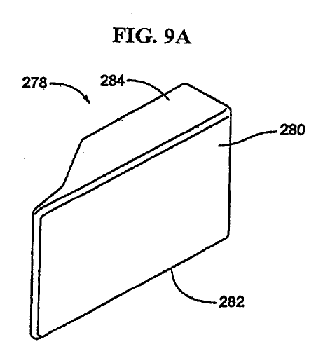

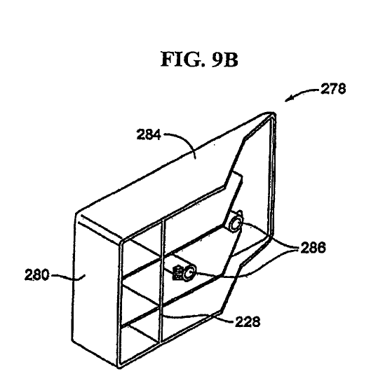

The mass confinement cell 210, 310 of the various embodiments of the present invention may further be fitted with an end cap 278 to finish the end of a wall, provide an end finish for a sharp turn (e.g. 90° turn) in the wall or to accommodate a partial confinement cell when a confinement cell must be cut for fitting. A front and back view of one embodiment of an end cap 278 is depicted in FIGS. 9A and 9B. In most embodiments, the end cap 278 will include a back surface 280 and side surface 282 that is textured and colored similar to the front panel 224 or fascia 254 of the mass confinement cell 210. Additionally, the top surface 284 of the end cap 278 may include a texture and color similar to the front panel 224 or fascia 254 of the mass confinement cell 210. In one embodiment, as depicted in FIG. 9B, the end cap 278 includes one or more securing pegs 286 that may be inserted into the lightening apertures 208 of the side panels 216. In alternative embodiments, the endcap 278 may include one or more snaps similar to the fascia or top cap that may fit into snap apertures positioned on the side panels of the frame. The end cap 278 may also include ribs 228 to provide stability to the structure.

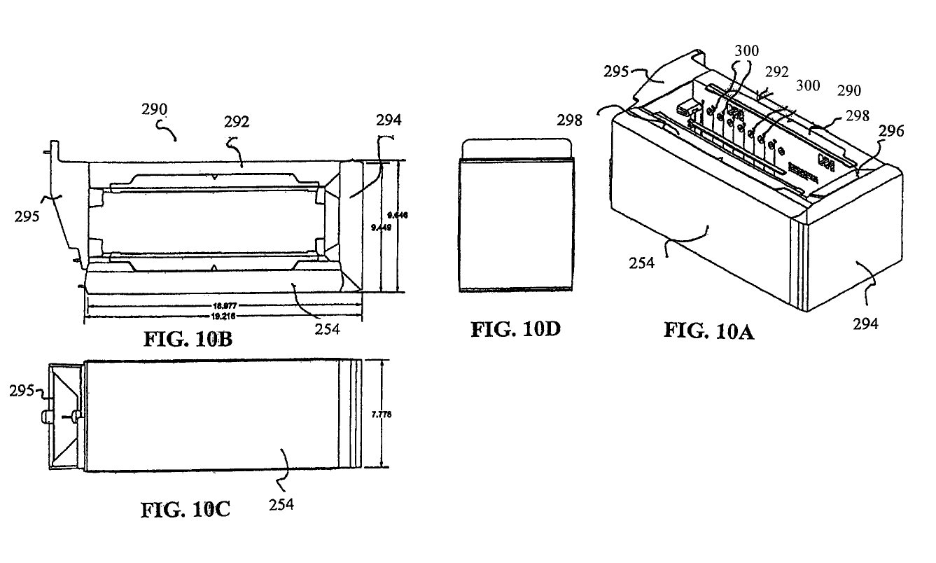

In yet another embodiment, the end of a wall constructed of mass confinement cells of the present invention may also be completed with a corner cell. FIG. 10A-D depicts one embodiment of a corner cell 290 having a frame 292, a fascia 254, a partial fascia 294 and a closing member 295. The frame 292 of this embodiment has a similar design to the frame of the mass confinement cells of the present invention. In this embodiment the frame 292 includes a front panel 296 that is configured to accept the partial fascia 294 and one or more side panels 298 that are adjoined to the front panel 296 with one or more securing mechanisms 22. The side panels 298 of the corner cell 290 have a similar general design as the front panel 24 of FIG. 10A. However, the side panels 298 further include one or more sets of apertures 300 that may be utilized to align and secure the closing member 295 to each of the side panels 298, thereby securing the side panels 298 together and forming a chamber. The sets of apertures are further aligned along each side panel 298 to allow for the corner cell 295 to be cut and still allow for the closing member to be aligned and secured to the side panels 298. The ability to be cut provides a opportunity during construction of the wall to easily create half cell units. In this embodiment, the side panels 298 are adjoined to the front panel 296 with living hinges (not shown), which comprise a thin flexible plastic (e.g. HDPE) that can bend into position without breaking when folding the frame 292 in an assembly position to secure the closing member 295. The frame of this embodiment further includes one or more securing mechanisms (not shown), such as clasps or snaps, that rigidly secure the side panels 298 to the front panel 296 when folded into assembly position. The securing mechanisms, in this embodiment, are attached to the side panels 298 to engage and lock the front panel 296 and side panels 298 into assembly position. In various embodiments, these panels 296, 298 are engaged and locked by passing snaps through snap apertures (not shown), which are located on the front panel 296. Alternatively, the snaps may adjoin opposing snaps positioned on the front panel 296 that hook to each other thereby locking the panels into position. Other securing mechanisms may be utilized in these embodiments, some of which are identified within.

In one embodiment of the present invention, the fascia 254 used with the corner cell 292 may generally be the same fascia that is utilized with the mass confinement cells of the present invention. Such a fascia 254 may be secured to the side panels 298 in a similar way as the fascia 254 attaches to the front panel 24 of the mass confinement cell as depicted in FIG. 1. In various embodiments, the partial fascia 294 is a smaller version of the standard fascia 254. In other embodiments a fascia may be molded to include both the fascia 254 and partial fascia 294 in a single unit that has a angled turn (e.g. a 90° turn).

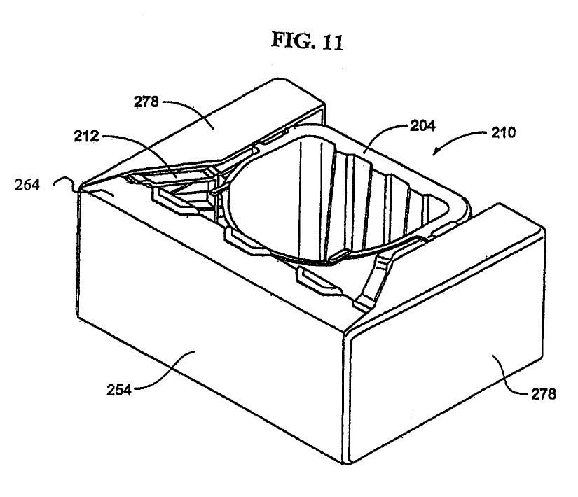

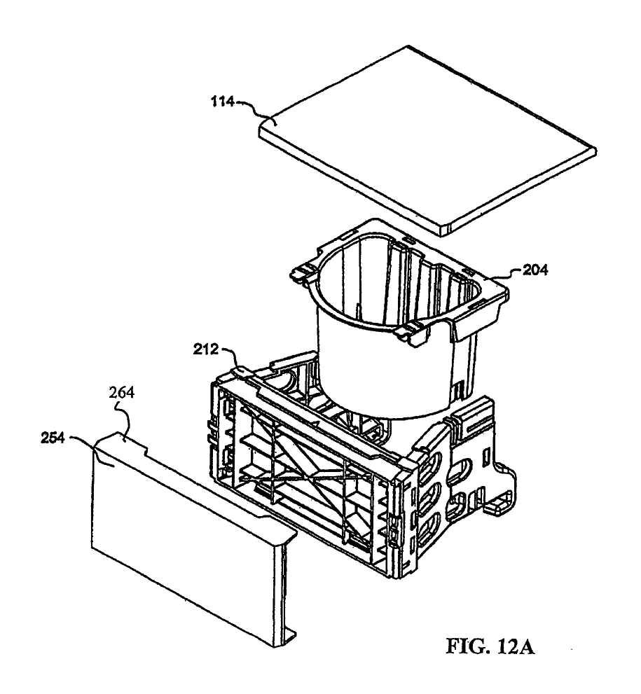

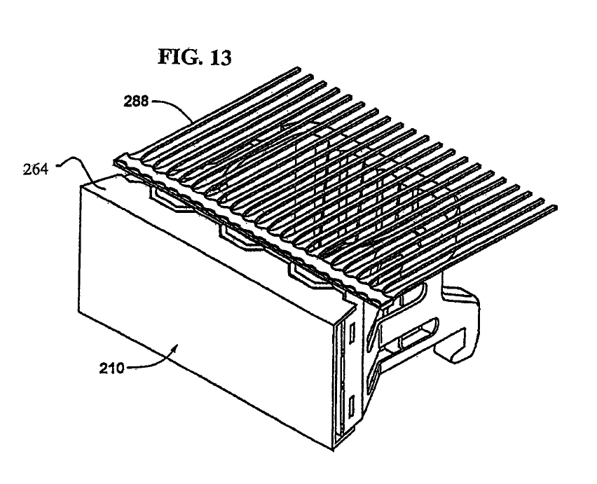

FIG. 11 depicts one embodiment of a fully assembled mass confinement cell 210 that includes end caps 278. FIGS. 12 and 12A depict exploded views of the components of two mass confinement cells of the present invention including a frame 212, load cell 204, fascia 254 and endcaps 278 or topcap 114. FIGS. 13 and 13A depict two embodiments of the confinement cell 210 of the present invention accommodating the securing of each cell 210 with geogrid 288. As depicted in FIGS. 11-13A the geogrid 244 may be secured to the frame 212 and/or load cell 204 by administering the grid over the grid fasteners 206.

The mass confinement cell embodiments depicted in previously disclosed FIGS. and the embodiments of the present invention are also especially advantageous for mega-cell products of sizes equal to or greater than one foot in height, two feet wide and one foot deep (e.g. greater than 2 feet in height, four feet wide and two feet deep) and multi-cell products (e.g. products that appear like multiple individual units that are approximately 3-36 in height, 2-4 feet wide and 9 inches to 4 feet deep) that are advantageous for the mass consumer market. Such large confinement cells and multi-unit cells allow for easy storage and transportation of such mega-cells and multi-cells by allowing them to flatten, thereby decreasing the space needed for large numbers of cells. In some embodiments of the confinement cells 210 of the present invention, a plurality of load cells 204 may be adjoined together and secured to the larger frame to reduce the flow forces of the fill materials in the larger walls. The load cells of the multi-cell embodiments may be adjoined with tabs that may be separated to curve the wall when desired. Furthermore, the multi-cell embodiments of the present invention may be utilized to install large sections of wall with few components and still provide the appearance of a multitude of individual cells.

As previously indicated the mass confinement cells 210, 310 of the present invention generally include a frame 212, 312 that has one or more side panels 216, 316 that engage and extend from the front panel 224, 324 back to engage with a back panel 214, 314. As depicted generally in a number of the FIGS., various embodiments of the present invention include side panels 216, 316 engaging the front panel 24, 224, 324 at angles to provide for a tapering of the confinement cell as it moves back in width. The angle formed between the front panel 224, 324 and side panel 216, 316 is generally less that 90° when the front panel 224, 324 is substantially straight and less than 150° when the front panel 224, 324 is rounded or beveled. In other embodiments, the angle is between about 45° and 85° for substantially straight front panels 224, 324 and between 60° and 110° for beveled and rounded front panels 224, 324. In various embodiments the side panels 16, 216, 316 may extend from the front panel 224, 324 at angles that would allow them to engage each other at the back of the confinement cell, thereby forming the back panel 214, 314 and chamber 220, 320 by their engagement (e.g. a triangle or diamond configuration). Finally, in various embodiments, the top edge of the side panels 216, 316 may slightly slope down from front to back, thereby providing a back end of the confinement cell that is slightly lower than the front of the confinement cell (e.g. 0.5-10 mm).

In various embodiments of the present invention, the mass confinement cell 210, 310 further includes a partial top panel that extends from the front panel 224, 324 or fascia 254, 354 that is exposed when a retaining wall is constructed. The partial top panel assists to close or partially close the top front portion of the confinement cell 210, 310 that may be exposed to the outer environment. In various embodiments, the mass confinement cells 210, 310 include a partial top panel that extends from the front panel 224, 324 or fascia 254, 354 back to no more than 80% of the depth of the confinement cell 210, 310. It is noted that cell depth is measured from the front panel 224, 324 or fascia 254, 354 to the back panel 214, 314 of the confinement cell 210, 310. In other embodiments of the present invention, such a partial top panel extends from the front panel 224, 324 or fascia 254, 354 no more than 50% of the depth of the confinement cell. In yet other embodiments the partial top panel extends from the front panel 224, 324 or fascia 54, 254, 354 no more than 35% of the depth of the confinement cell (e.g. 5% to 30%). Such a partial top panel provides for at least a partial sealing of the confinement cell at the top front portion, of which may be exposed when the retaining wall is constructed in a configuration wherein the wall inclines back toward the surface or slope intended to be protected. It is noted that in various embodiments the top panel may further include one or more planting apertures (not shown) that may allow plant growth from the top surface of the confinement cell 210, 310. As previously suggested, the open top and bottom of each mass confinement cell 210, 310 allows for the receiving and commingling of fill material that may flow from and through the confinement cell 210, 310 to one or more adjacent cells 210, 310 below or above. FIGS. 11-13A depicts one embodiment of a front panel 224 that includes a partial top panel 264.

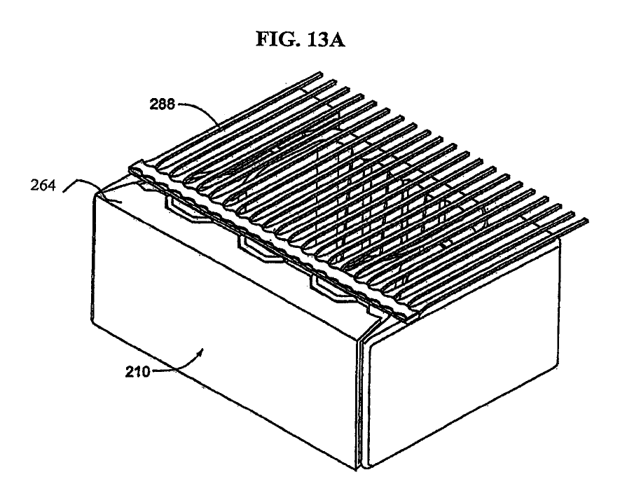

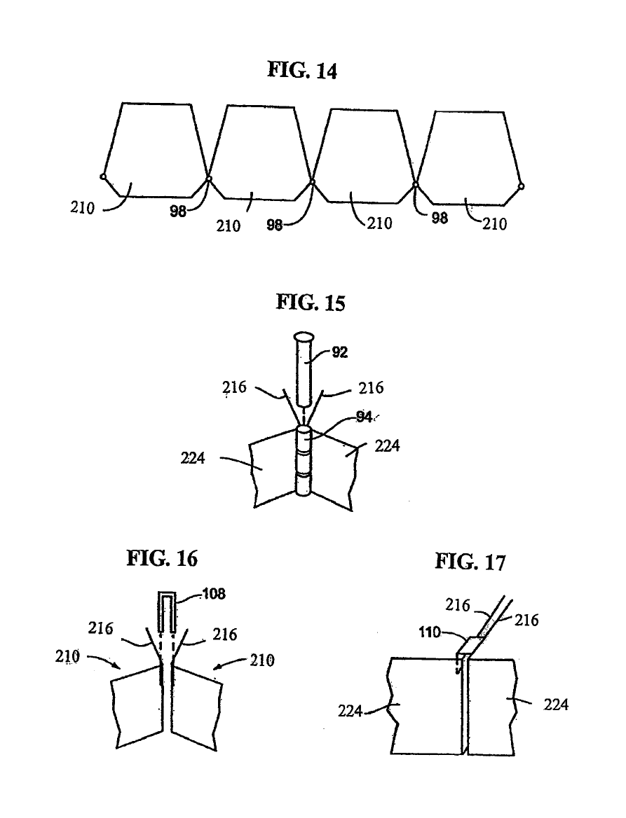

FIGS. 14-17 depict other embodiments of the present invention wherein the mass confinement cells 210 include a side interconnecting device 98. It is noted that in the mass confinement cell 210 embodiments, the interconnecting device 98 may be a securing mechanism as described above or a variation thereof. In various embodiments, as depicted in FIGS. 14 and 15 the interconnecting device 98 includes a peg and socket system having one or more insertable pegs 92 to adjoin two or more confinement cells by inserting the pegs 94 into threads 94 that form a socket. The sockets are generally positioned on an edge or just inside the edge of the front, side and/or back panels 224, 216, 214. The sockets may be integral to the front or back panels 224, 214 or may be secured to the panels 212, 216, 214 in any manner known in the art. The pegs 92 are configured to be securely receivable in the sockets and may be configured to swivel the confinement cell 210. The insertable pegs 92 can be made of any shape and size, which can be securely fit into the sockets.

FIGS. 14A-C depict another embodiment of a side interconnecting device 98 having an alternative peg and socket configuration. As depicted in the frame corner close up views of FIGS. 14B and 14C the frame 212 includes a side interlocking device 98 having an integral peg 92 that is received by a socket formed by integral threads 94. The peg and socket system allow for the adjacent cells to interconnect thereby limiting movement of cells during filling and promoting alignment of the assembled row of cells. In operation, the peg 92 of a cell may be pushed against the opening between the threads 94 of an adjacent cell until snapped into position thereby connecting the two cells. The peg and socket system of this embodiment also allows the adjacent cells to swivel by the peg rotating within the socket thereby allowing for curving of walls at desired locations.

Alternatively, in one embodiment of the present invention side by side adjacent confinement cells 210 may be adjoined with a clipping device 108. In one embodiment as depicted in FIG. 16, the clipping device 108 may be configured in a U shape and sized to snuggly fit over the side panels 16 of two adjacent confinement cells.

FIG. 17 depicts an additional embodiment of the present invention, similar to hook attachments, wherein the mass confinement cell 210 includes an interlocking feature that comprises a hook or peg 110. An optional pocket (not shown) may also be placed in the confinement cell 210 for receiving the hook 110 from adjacent confinement cells 210. In such an embodiment one or more hooks or pegs 110 extend from one side panel 216 of a mass confinement cell 210 and may be inserted over the opposite side panel 216 of an adjacent cell 210. Such interlocking mechanisms provides for a overall secure retaining wall structure by reducing the amount of movement that may occur during filling with unsecured individual cells.

It is noted that other landscaping products, such as boulders or rocks, pavers and edgers may be imaged in a similar fashion as described above and coated with an polymer adhesion paint in a similar technique as described below.

In other embodiments of the present invention, wall covering products may be imaged, textured and painted to provide the appearance of cut or quarried stone or rock, wood or brick. Examples of such wall covering products may be found in U.S. patent application Ser. No. 11/872,812, the entire contents of which are incorporated by reference herein.

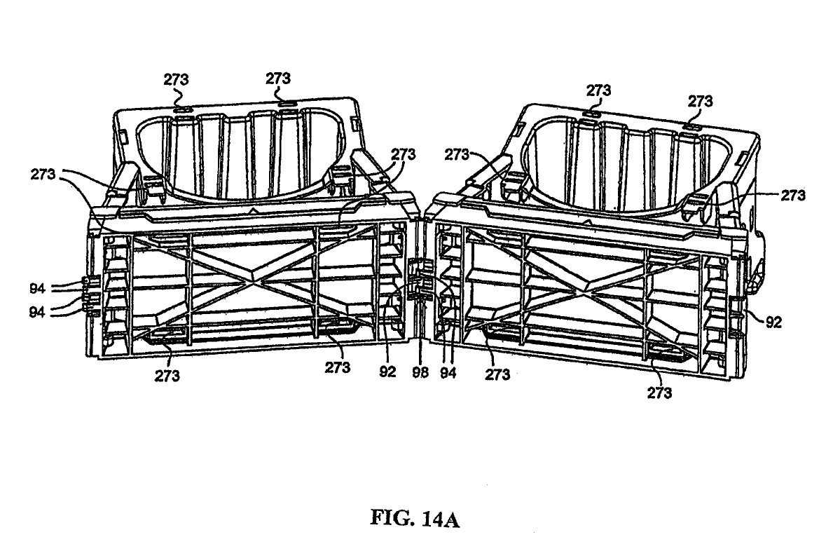

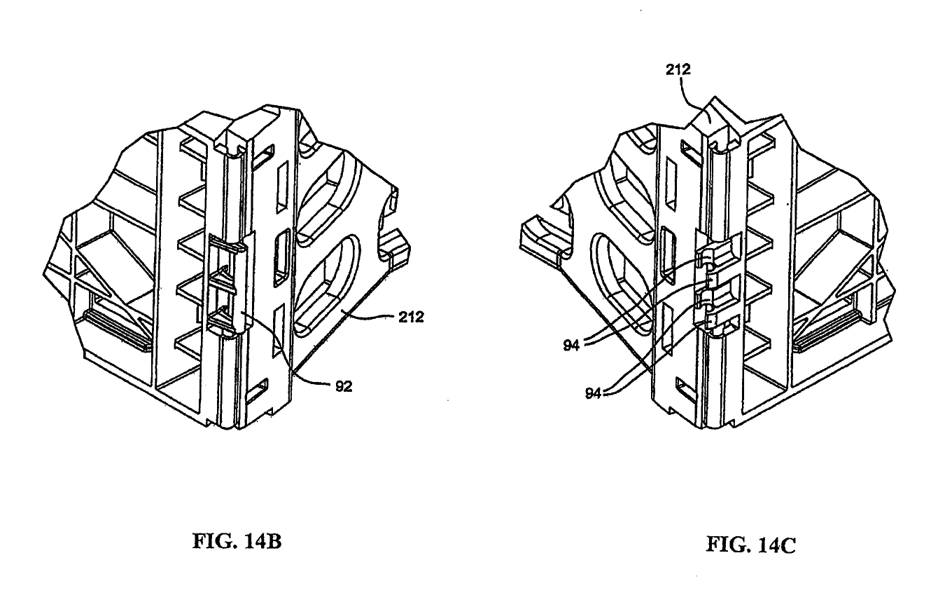

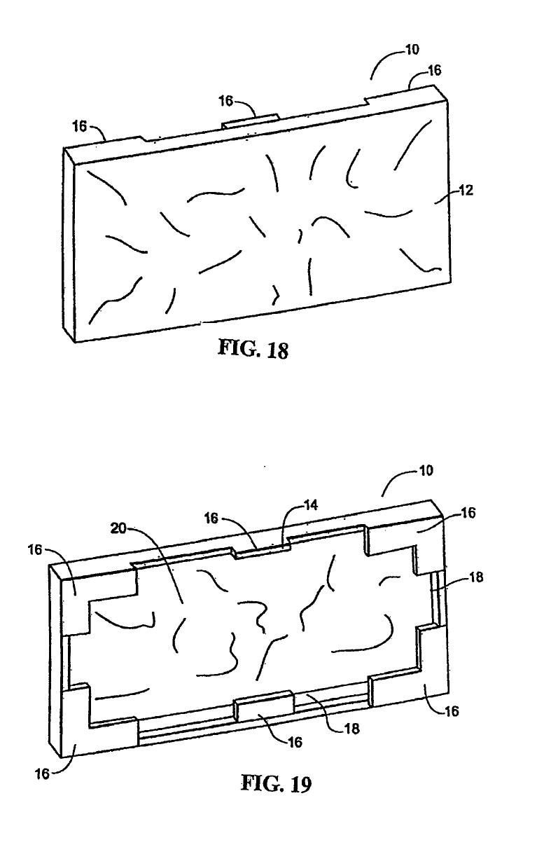

FIGS. 18 and 19 depict one embodiment of the polymeric or composite veneering product of the present invention comprising a veneering panel 10 including a front surface 12 having relief and/or texture and a back surface 14 having one or more attachment platforms 16 for securing the veneering panel 10 to a surface. It is noted that the attachment platforms 16 may be alternatively adjoined to the sides of the panel 10 rather than positioned on the back surface 14 depending on the type of attachment means or panel designs. The front surface 12 of the veneering product may comprise one or more colors, textures, degrees of relief and/or designs. For example, as depicted in FIG. 18, one embodiment of the veneering panel 10 may appear as a single cut stone. In many embodiments of the present invention, the front surface design is obtained by imaging a natural surface, such as stone, rock, wood or brick. Imaging a natural surface provides a panel that simulates the natural surface and give the most aesthetic appearance. An explanation of imaging is provided below.

In some embodiments of the present invention the hollowed back surface may be filled with a sound deadening and/or insulating material. For example, an insulating foam (e.g. a polyurethane foam) may be sprayed or applied to the back surface of each panel to provide additional sound and/or thermal insulation.

In various embodiments of the present invention, as depicted in FIG. 19, the back surface 14 may be cored or hollowed in a similar replica image of the front surface 12 by including a back surface plate in the mold that has at least a partial replica image of the front surface 12 of the panel 10. In production, the melted resin would be injected between the front and back surface plates to form each panel 10. As previously mentioned, the hollowing of the back surface 14 reduces raw materials and in some embodiments provides a substantial uniform thickness for the panel, thereby maintaining the strength and durability of the panel 10. The uniform thickness also provides benefits in molding the panels 10 by evening the cooling of all portions of the panel 10 during molding. In other embodiments of the present invention the cored back surface 14 may further include one or more ribs (not shown) that extend from the top of the panel 10 to the bottom of the panel and/or from one side to the other side. Such ribs 22 allow for additional stability and structure to the panel and provides additional durability to address unwanted impacts with the panel 10.

The general plastic thickness of the panels of the present invention may vary depending upon the desired rigidity and also the manufacturing process (e.g. panels of structural foam will generally be thicker than panels that are high pressure injection molded). However, various embodiments of the panels of the present invention will have an average thickness of approximately 50 mils to 500 mils. In various embodiments the average thickness will be approximately 80 mils to 300 mils. In additional embodiments the average thickness of the panels will be approximately 120 mils to 250 mils. It is noted that portions of the panel, such as the attachment platforms or ribs, may be of a greater thickness, but a majority of the panel 10 will generally include the thinner wall thickness.

Furthermore, the front surface of each panel 10 may include various degrees of relief, thereby in some embodiments, providing the appearance of natural cut stone, rock or wood. The degrees of relief generally highlight the texture of the surface and are exhibited by the peaks and valleys present. The degrees of relief may vary depending upon the desired appearance. For example, various embodiments of the present invention may include large amounts of relief (e.g. up to 10 cm from high point to low point) providing a very rough texture. In other embodiments, the relief may be of average degree (e.g. up to 5 cm). And in yet other embodiments, the relief may be somewhat mild (e.g. up to 1.5 cm).

In various embodiment of the present invention, the front surface 12 of the panel 10 may be flat, rounded or beveled. The front surface 12 of this embodiment may include a beveled front having one or more bends, slants or creases in the front surface 12. In some embodiments the beveled front surface 12 takes on a tri-panel appearance, such as a beveling or slanting down at the edges. It is noted that the front surface 12 may also be rounded, substantially flat and/or include positions of relief to provide a more natural appearance.

As previously mentioned, embodiments of the front surface may be flat, rounded, include texture and relief and/or beveled to accommodate molding or fabrication (e.g. painting) to provide the desired appearance. In various embodiments of the present invention the front surface is produced by imaging an actual natural surface, such as natural stone, rock, brick or wood. The imaging of the natural surface can be performed by processes such as cast imaging of the natural surface or by digital scanning the natural surface. When cast imaging the natural surface a mirror image of the surface can be produced by providing a casting material, such as silicone, ceramics or fine sand, and casting it over and/or around the natural surface. Once the casting material sets or has formed a mirror image of the natural surface the object casted is removed from the newly formed mold of the natural surface and an opposite image or negative of the natural surface has been produced. Next the negative image can be cast again with a solidifying material to produce the positive image of the natural surface. Such a process produces a casting that captures the texture and relief of the natural surface. Once the casted mirror images (i.e. positive and negative) are produced, a mold and/or a mold insert manufactured from a suitable mold material, such as aluminum, steel or a ceramic, can be produced for mass manufacture by administering the mold material to the positive and/or negative casting to form the production mold. In various embodiments of the present invention, a very fine sand or ceramic is used to provide a detailed negative and/or positive image thereby providing the desired detail found in the natural surface which then can be transferred to a more durable steel or aluminum production mold for mass manufacture of panels having one or more natural surface images. Cast imaging of the natural surface may be performed by a cast foundry. Foundries that may be used to prepare such castings include but are not limited to Arrow Pattern and Foundry Company, 9725 South Industrial Drive, Bridgeview Ill. and WK Industries, 6120 Millett Ave., Sterling Heights, Mich.

Alternatively, a mold may be prepared by digitally scanning the natural surface, such that the surface of a stone, brick or piece of wood. Once scanned, a mold can be produced from a suitable mold material for mass manufacture of the front panels or fascias having a front surface supporting the scanned image. It is noted that the core side of the mold may be produced by either digitally scanning or casting the natural surface. Such imaging provides a core that will substantially mirror the front surface of the mold and thereby provide a manufactured panel 10 that is relatively uniform in thickness.

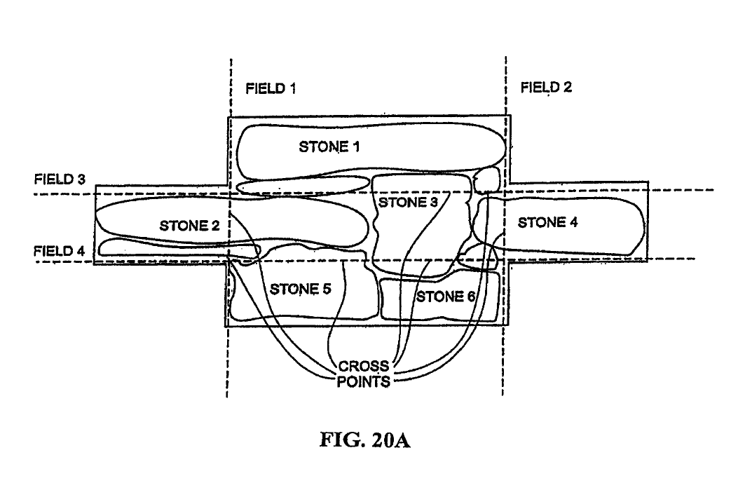

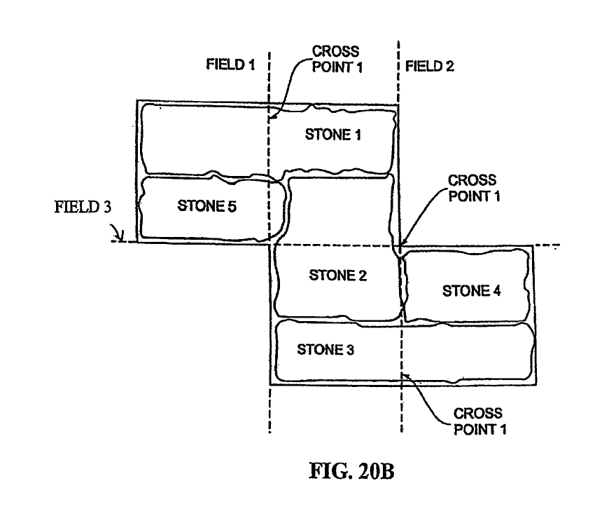

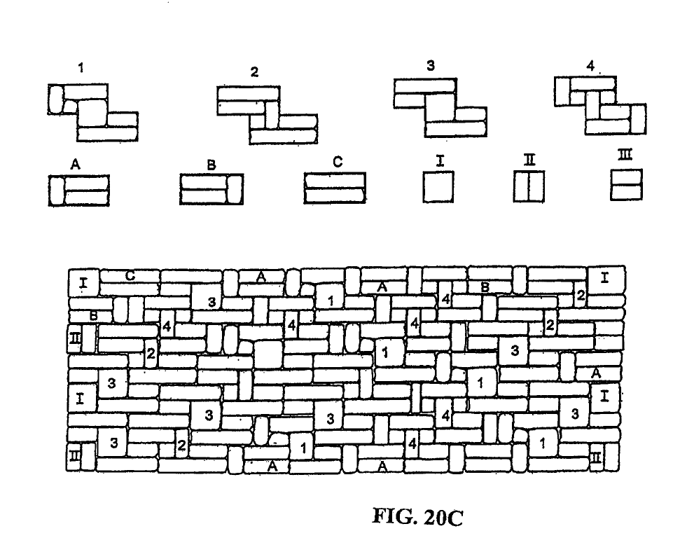

As previously mentioned the panels of the present invention may take on the image of a single stone, brick or piece of wood. Alternatively, as depicted in FIGS. 20A-C, the veneering panel 10 may have the appearance of multiple stones. For example, a single panel may appear as a ledgestone configuration having a plurality of cut stones as depicted in FIG. 20A. In yet another embodiment, as depicted in FIGS. 20B and 20C the veneering panel 10 may appear to include a plurality of field stones or a plurality of cut stones in a random Ashlar pattern. Additionally, as previously suggested, the front surface 12 may include one or more colors, textures and/or degrees of relief to provide a natural stone, brick or wood appearance.

When covering a wall with panels that have the image of multiple items, such as stones, wood or brick, it is important to avoid the appearance of a reoccurring pattern. When utilizing such products it is not uncommon that visually unacceptable straight lines are formed when individual items, such as stones, are aligned, thereby forming long vertical or horizontal breaks in the wall wherein a series of stones or wood planks end in the same location. Such breaks are perceived as being an unacceptable pattern. Therefore, embodiments of the present invention are designed to provide imaged items, such as stones, brick or wood planks, in positions which break designated fields or planes. In such embodiments, individual stones are positioned on a majority of the panels (e.g. >50% of the panels or in other embodiment >75% of the panels) so as to break at least two or more fields/planes that extend partially along the perimeter of the panel, but also pass through the interior of the panel. In other embodiments of the present invention, individual stones are positioned on a majority of the panels (e.g. >50% of the panels or in other embodiment >75% of the panels) so as to break at least three or more fields/planes that extend partially along the perimeter of the panel, but also pass through the interior of the panel. In yet other embodiments of the present invention, individual stones are positioned on a majority of the panels (e.g. >50% of the panels or in other embodiment >75% of the panels) so as to break at least four or more fields/planes that extend partially along the perimeter of the panel, but also pass through the interior of the panel. If such fields are not broken by a strategically placed stone a reoccurring break pattern on the wall may become recognizable.

FIG. 20A depicts a T-unit panel 10 that includes four fields or planes that extend along the periphery of the panel 10, but also pass through the interior of the panel. In the T-Unit depicted in FIG. 20A at least one individual stone is found to break each of the four fields. The fields are designated by dashed lines and the field breaks are outlined with boxes. For example, stone 2 breaks field 1; stone 4 breaks field 2; stone 3 breaks field 3 and stones 3 and 5 break field 4.

FIG. 20B depicts another embodiment of the present invention wherein individual imaged items, such as stones, are positioned on a Z-unit panel 10. The Z-unit panel of this embodiment generally has 3 fields/units wherein one or more imaged items breaks each of the fields. For example, stone 1 breaks field 1; stone 2 breaks field 3 and stone 3 breaks field 2. The fields are designated with dashed lines and the breaks are designated in the boxes. Finally, FIG. 20C depicts a partial wall having at least 4 different Z-unit panels 1, 2, 3, 4 and a few finishing panels A, B, C, D and I, II, III. As can be seen in the wall, a wall constructed utilizing a majority of panels that break the fields avoid the unacceptable straight line breaks in the wall.

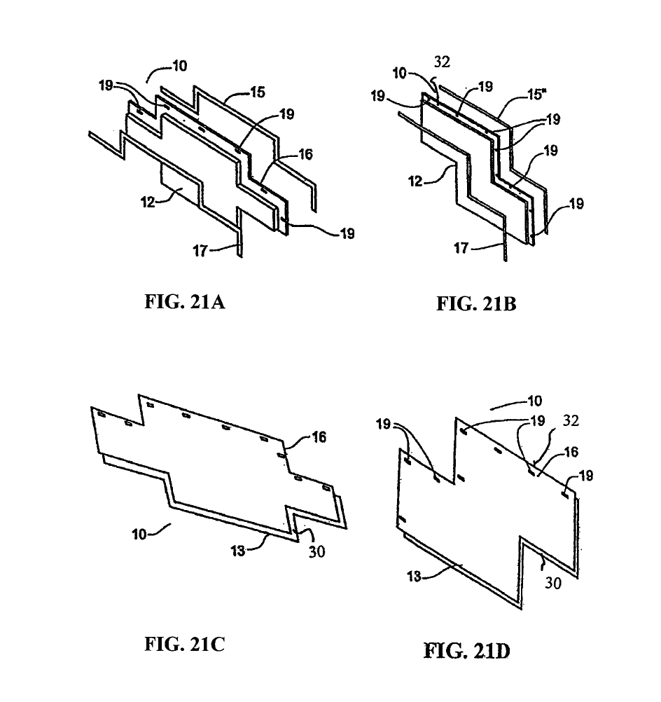

Various embodiments of the panels of the present invention may further include interlocking members that allow the panels to overlap and/or secure to each other. FIG. 21A-D depict embodiments of the present invention wherein the panel 10 includes a front overlap 30 and a back overlap 32. It is noted that such interlocking panels may also be found on the sides of the panels 10 rather than or in addition to being positioned on the top and bottom of the panels 10. Additionally, the front overlap 30 and back overlap 32 may have fastening devices to mechanically interconnect the panels to each other. Examples of fastening devices include, but are not limited to snaps, peg and slots, clips, adhesives, screws, rivets, nails and combinations thereof. In various embodiments screws, adhesives and combinations of these are utilized to secure the panels to the substrate. Further explanation of such panels are identified below.

FIGS. 21A-D depict embodiments of the present invention that may be secured to a substrate, such as a wall with adhesives alone or with adhesives and screws, nails or rivets. As depicted in FIGS. 21A and 21C a T-unit panel 10 having a front surface 12 and an attachment platform 16 may be secured to a substrate, such as a wall, with one or more strips of adhesive 15 and secured to the panel above with a second strip or strips of tape/adhesive 17. Alternatively, rather than utilizing adhesive to secure each panel to the substrate, screws, nails, or rivets may be used to secure each panel 10 to the substrate by passing the screw, nail or rivet through one or more fastening apertures 19 positioned on the attachment platform 16. In various embodiments, screws, nails or rivets can simply be passed through the polymer attachment platform 16 without fastening apertures 19. It is noted that a depression 13 approximately the same width as or slightly greater in width than the attachment platform 16 may be positioned on the back bottom side of the panel 10 to nest the extra width of the tape 17 and/or attachment platform 16 of the adjacent panel, thereby allowing for a more flush system. A back perspective view that illustrates the depression 13 is depicted in FIG. 21C.

FIGS. 21B and 21D depict another embodiment of the present invention, wherein a Z-unit panel 10 having a front surface 12 and an attachment platform 16 may be secured to a substrate with one or more strips of adhesive/tape 17 and secured to the panel above with a second strip or strips of adhesive 17. Alternatively, similar to the T-unit described above, screws, nails, or rivets may be utilized to secure each panel 10 to a substrate by passing the screw nail or rivet through one or more fastening apertures 19 positioned on the attachment platform 16. In various embodiments, screws, nails or rivets can simply be passed through the polymer attachment platform 16 without fastening apertures 19. Similar to the T-unit embodiment, a depression 13 approximately the same width as or slightly greater in width than the attachment platform 16 may be positioned on the back bottom side of the panel 10 to nest the extra width of the tape and fastening ridge of adjacent units thereby allowing for a more flush system. A back perspective view that illustrates the depression 13 on a Z-unit panel is depicted in FIG. 18D.

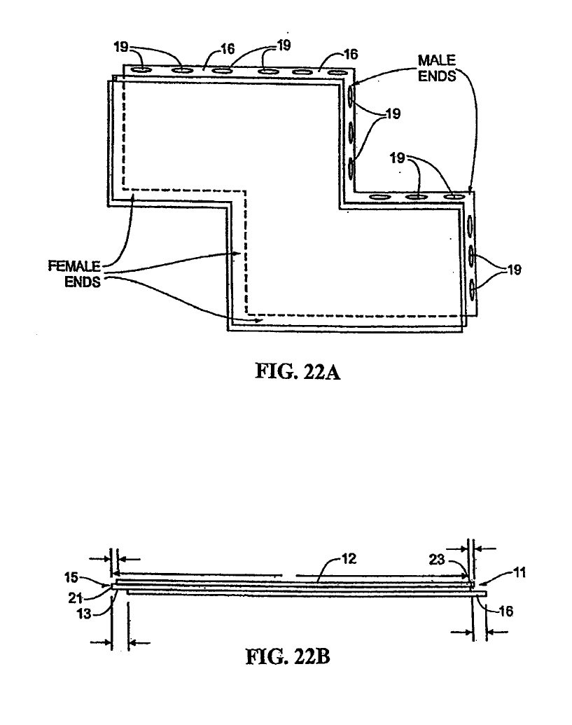

FIG. 22A depicts another embodiment of the invention that includes a tongue and groove panel attachment. The Z-unit panel 10 of FIG. 22A includes attachment platform 16 on the male end 11 and a depression 13 for accepting the attachment platform 16 positioned on the female end 15 of the panel 10. The attachment platform 16 may include one or more apertures 19 that are configured to accept screws, nails or rivets for securing the panel 10 to a substrate, such as a wall. FIG. 19B depicts a side view of the panel of FIG. 22A wherein the panel 10 includes a tongue 21 positioned on the female end 15 and a groove 23 positioned on the male end 11. It is noted that the tongue 21 may comprise multiple tabs rather than a single elongated tongue that extends along the majority of one or more sides of the panel 10. Furthermore, the groove 23 may be a series of apertures positioned along one or more sides of the panel 10 rather than a groove 23 that extends across the entire length of the one or more sides. However, it is generally recommended that the groove 23 extend along the entire length of the one or more sides to provide more forgiveness in assembly. It is also noted that the tongues and grooves may be positioned on either opposite end of the panels (e.g. top/bottom, bottom/top . . . ).

During assembly of a wall using the embodiment depicted in FIGS. 22A-B, a first panel 10 is positioned over a second panel that has been secured onto a wall. Next, the tongue 21 of the first panel is inserted into the groove of the second panel and the first panel is pushed down or up into the groove until the panel is in the proper positions. Next the first panel is secured to the wall by adhering the attachment platform 16 to the substrate, such as a wall, with adhesive/tape or by screwing, nailing or riveting the attachment platform 16 to the substrate with screws, nails or rivets.

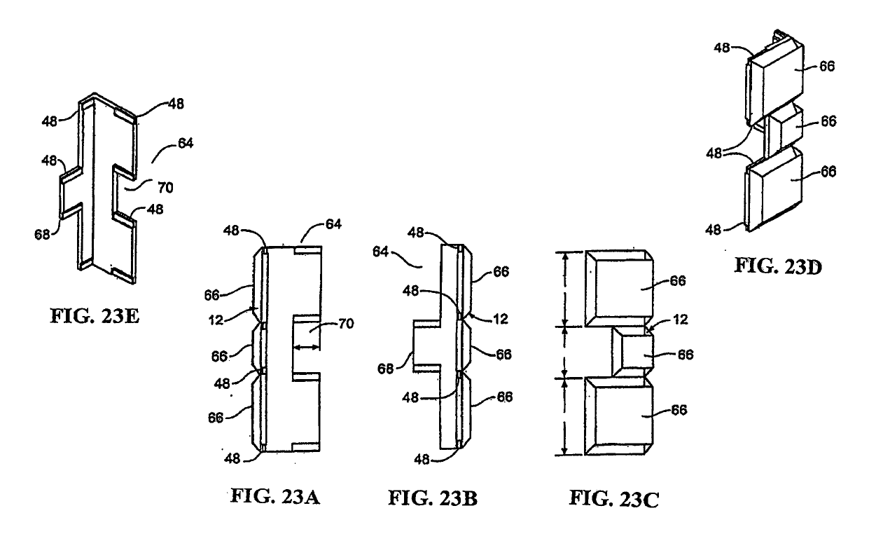

FIGS. 23A-E depict one embodiment of a corner panel 64 that may be utilized with the panels 10 described above. In this embodiment, the corner panel 64 generally includes a plurality of stones 66 molded into the front surface 12. However, in other embodiments, the corner panel 64 may also be molded to feature only a single stone. In some embodiments that include a plurality of stones in a single panel, the panel may include a stone projection 68 that may be positioned between two panels 10 and/or a recess 70 that may receive a regular panel 10 that is in a Z or T configuration. It is noted that the corner panel projection 68 may be inserted into a corner panel recess 70 to complete the covering of a wrap around corner. Similar to the panels described above, the corner panels 64 may include ridges 48 that extend along one or more sides of the corner panel 64 that may be inserted into the grooves of the regular panels 10 to adjoin the corner panels 64 to adjacent panels 10 and secure the corner panels 64 to the substrate.

The panels 10 and corner panels 64 may also be of varying size. In some embodiments of the present invention the panels 10 are greater than eight square feet. In yet other embodiments of the present invention the panels 10 are approximately two to eight square feet. In still other embodiments the panels 10 are approximately ¼ to four square feet or are ½ to 3 square feet. Additionally different size panels may be utilized to provide an irregular pattern (e.g. Ashlar or ledgestone patterns).

As previously suggested the wall covering product of the present invention may be utilized in the construction of any type of wall or surfacing project wherein a natural appearance, such as stone, brick or wood, is desired. In application, a substrate surface may be veneered with various panel 10 embodiments of the present invention by applying one or more of the panels to a surface of a substrate. In a number of embodiments of the present invention the process begins by preparing the substrate to be resurfaced by cleaning the substrate surface. The substrate surface may be a wall, such as an existing wall that is substantially planar and made of one or more materials, such as wood, drywall, masonry, sheathing, sheet metal, insulation (e.g. foam insulation), poured concrete, cinder and concrete block, segmental retaining wall block, brick and the like. In other embodiments, the substrate may be prepared by securing a grid system or backing to the substrate surface. Upon identifying the substrate, one or more panels are administered to the surface of the substrate or an attached grid system or backing previously applied to the substrate surface.

In various embodiments of the present invention a pattern can first be placed on the substrate surface to be covered with panels of differing shapes. For example, a pattern, such as an Ashlar pattern may be applied to the wall by a rubbing or stencil, thereby leaving an image of the desired placement positions of the various shaped panels. Once the stencil pattern is administered to the wall or surface, the equivalent shaped and sized panel is applied to the pattern similar to the placement of puzzle pieces in a jigsaw puzzle. It is noted that more than one pattern may be applied to the same wall thereby giving a random final appearance.

The panels of the present invention may be administered to the surface or the grid system or backing by one for more fasteners, such as adhesives, rivets, screws, nails, two sided tapes, ball and socket attachments, snaps, hook and pile attachments, sliding brackets, clipping devices (e.g. barb clip and radius clips) sliding brackets, structural VELCRO® or other attachment means known in the art that would secure the panels of the present invention to the substrate or grid system or backing. It is noted that combinations of the fasteners may also be utilized to secure the panels of the present invention. For example, various embodiments may utilize a combination of screws, nails or rivets with one or more adhesives to secure the panels to a substrate or the grid system or backing.

In a number of embodiments of the present invention each veneering panel is adhered to the substrate and/or adjacent panel with a two sided tape that includes an adhesive that has an affinity to polymeric materials. For example various embodiments of the panels may be secured with adhesives, such as the two sided VHB and acrylic or polyurethane foam tapes produced by 3M. In such embodiments of the present invention, the two sided tape may be adhered to the attachment platforms on the back surface of each panel. The backing of the two sided tape is removed and the panel is attached to the wall or substrate in the desired location. Examples of such tapes that may be utilized with the panels 10 of the present invention include 4952, 5952, 5925 and 5962 VHB two sided adhesive tapes manufactured by 3M, 3M Center, St. Paul, Minn. 55144-1000. Another adhesive tape that may be utilized includes, but is not limited to, the 4466W Double Coated Polyethylene foam tape manufactured by 3M. Other examples of suitable two sided tapes that may be utilized with the panels of the present invention include, but are not limited to, 3M® Double Coated Polyethylene Foam Tape 4492W and 4462W, 3M® VHB® Acrylic Foam Tape 5952 and 5925 and 3M® Double Coated Urethane Foam Tape 4016. Additionally adhesive sealants, such as the 4000 and 5200 sealants produced by 3M may also be used to secure the panels 10 to a substrate, such as a wall. The sealants may be applied on the substrate surface or on the back surface of the panel prior to pressing the panel to the surface of the substrate by any means known in the art (e.g. spraying or spreading). However, it is important that the adhesive (e.g. tape or sealant) utilized be appropriate to adhere a resin based product. The examples listed above provide this feature. In general, the curing of the adhesive properly affixes the panel to the substrate. Curing times vary depending on the adhesive, but many will cure within less than 72 hours.

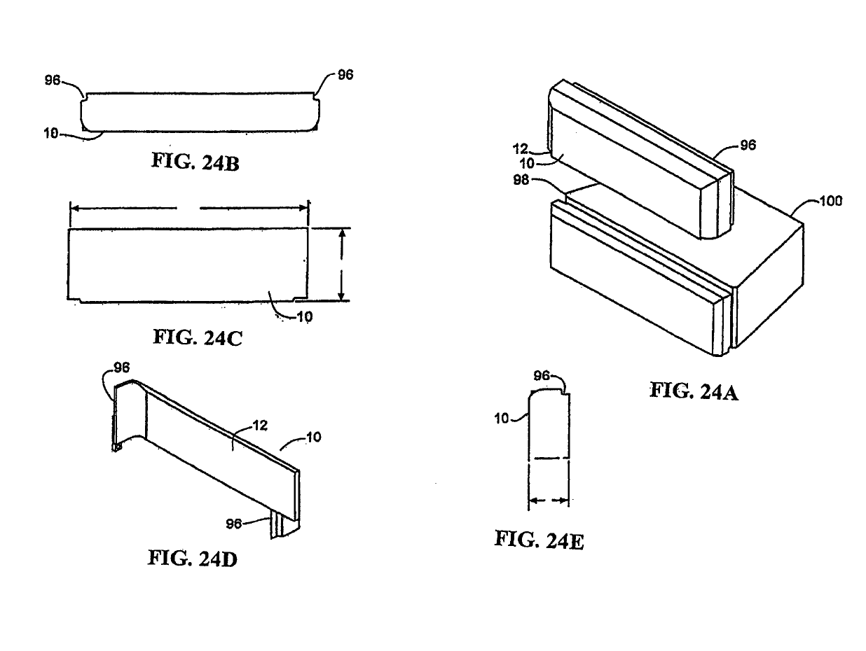

As previously identified, any wall may be covered with the veneering product of the present invention. For example, segmental retaining wall block may be adapted to accept and secure a veneering panel of the present invention. Such a panel would provide additional durability, deterioration resistance and aesthetic appearance to the normally problematic concrete product. FIGS. 24A-E depict one embodiment of the panel 10 that may be utilized to cover a concrete block. The panel 10 of this embodiment of the present invention, generally includes a front face 12 adjoined to one or more groove attachments 96. The front face 12 may be molded and/or fabricated as described herein to include a colored and textured surface that replicates a natural appearances, such as stone or wood. For example, in various embodiments of the present invention, a stone or wood plank may be imaged to capture the desired face and then coated with one or more polymer paints to capture the natural appearance. It is noted that other fabrication processes, such as in-mold decoration or solid surface coating, may be utilized in manufacturing the block panels of the present invention. In this embodiment, the panel 10 may extend around the side of a concrete block 100 wherein the one or more groove attachments 96 are configured to insert and secure into a groove 98 positioned on the concrete block 100. The groove attachments 96 and accepting grooves 98 may be of a variety of shapes and sizes.

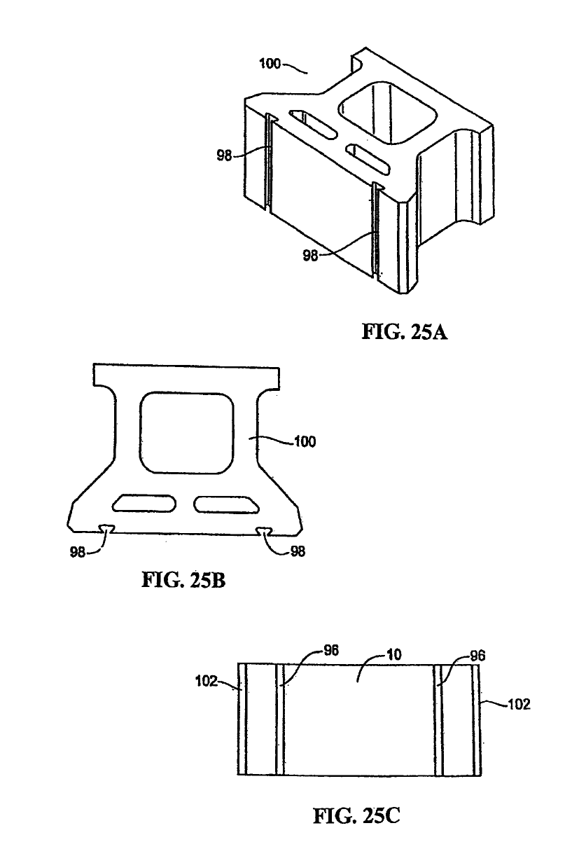

Another example of a panel 10 that may be utilized to cover concrete blocks is depicted in FIGS. 25A-C. In this embodiment, the groove 98 and groove attachment 96 are in the shape of a dove tail or dogbone, thereby providing for the secure attachment of the panel 10. FIG. 25B depicts the back view of a panel that includes two groove attachments 96 that are shaped in a dogbone configuration and a panel 10 that includes wrap around edges 102.

In many embodiments of the present invention, the appearance of the landscaping products, such as the front panel 224, 324, partial top panel (not shown), fascia 254, 354, the boulders, pavers, edgers, veneering panels or any portion of these landscaping or wall covering products that are intended to be seen, generally include an earthen appearance or other aesthetically pleasing design and color. When referring to the manufacture, molding and coating/painting of the products of the present invention, the term “substrate” may be used to describe the front panel 224, 324, partial top panel (not shown), fascia 254, 354 or any other portion of the mass confinement cell 210, 310, the veneering panel of the wall covering, the boulders or pavers or any portion of these products that are intended to be seen.

In various embodiments of the present invention, the earthen appearance, such as a stone, rock, boulder or wood appearance may be accomplished by coating the visible surface substrate with a polymer adhesion paint. For example, in some embodiments of the present invention the texture and color of substrate (e.g. the mass confinement cell 210, 310, the molded boulders, the pavers, the edgers or the veneering panels) may be formed by thermal molding one or more resins (e.g. recycled or virgin resins) that include colors and other additives in a mold that has a desired texture.

As previously mentioned, the products of the present invention may be manufactured from a deterioration resistant, substantially rigid composite or polymeric material including, but not limited to, plastic (e.g. recycled or virgin), a rubber composition, fiberglass, or any other similar material or a combination thereof. Preferable materials comprise light-weight and slightly flexible polymers, such as high and low density polyethylene (HDPE or LDPE) and polypropylene (PP). It is noted that a polypropylene copolymer may be utilized with the present invention, but it is recommend that the polypropylene copolymer have a polyethylene content no greater than 30% polyethylene and in other embodiments no greater than 20% polyethylene. However, other plastics may also be used. Examples of other plastics include, but are not limited to acrylonitrile-butadiene-styrene (ABS), poly(butylene terephthalate) (PBT), poly(cyclohexanedimethylene terephthalate) (PCT), styrene-acrylonitrile copolymers (SAN), polystyrene, polycarbonate, polyvinyl chloride (PVC), polyurethane, copolymers and combinations thereof. It is also noted that the deterioration polymeric materials may also be utilized with filler materials or recycled filler materials, such as titanium, carbon fibers, talc, glass, saw dust, cellulose fibers, paper byproducts and the like. Generally, the embodiments of the present invention may comprise any type of material that would have the similar characteristics to plastic, vinyl, silicone, fiberglass, rubber or a combination of these materials.

One other material that may be utilized with the present invention may be a thermoset. For example, a bulk molding compound (BMC) or thermoset that includes one or more polyester resins, glass fibers and other additives may be utilized to manufacture one or more components of the present invention. Various embodiments of thermosets and BMC is manufactured and/or molded by Bulk Molding Compounds, Inc. 1600 Powis Court West, Chicago Ill. 60185 and Kenro Incorporated, a Carlisle Company, 200 Industrial Drive, Fredonia, Wis. 53021.

It is noted that the material utilized in the present invention should be rigid enough to hold its form upon installation, impact and/or when placed in contact with other objects. Another material may be comprised of a material similar to that utilized in the production of some types of garbage cans or the utilization of recycled rubber from objects such as tires. Such materials would be capable of holding rigidity and still offer flexibility upon impact. Also, such materials have the ability to regain its original form when the impact force has been removed or completed.

Embodiments of the present invention may also vary in appearance. Since embodiments of the present invention may be manufactured by a process such as injection molding, structural foam molding, injection molding using chemical and other foaming agents, extrusion, thermo-forming, compression molding, roto-molding and the like, the molds may include any type of design, size and shape. Furthermore, the substrates could be molded in almost any type of texture, relief and/or configuration. For example, the substrates may be designed to appear like a plurality of field stones, cut stones, bricks, wood planks, or any other natural wall construction material. In other embodiments, multiple substrates could be molded to include designs that, when positioned on a retaining wall, would complete a larger single design, such as the spelling of a company or school name in large letters or the completion of a large image. It is noted that embodiments of the present invention may also be used in conjunction with other wall products, such as vinyl siding, bricks, stones and the like.

Each of the substrates of the present invention may be textured and include color and/or other additives (e.g. U.V. inhibitor, texture enhancer, metal or glass particulates and the like) to provide protection to the substrates and other components and/or provide the desired natural appearance. Generally, the substrate surface visible to the observer will include a molded and/or fabricated texture and/or pattern in the deterioration resistant material. In various embodiments of the present invention the exposed surface of the substrate will have a natural appearance. For example, the exposed surface of the substrate may be textured and colored to have the appearance of rock, natural stone, brick, wood, or any other natural earthen appearance.

In some embodiments of the present invention, a color that is close to the final natural appearance color of stone, rock, wood and the like may be integrated into the polymers that are molded. For example, an integral color may be incorporated into recycled resin to provide a close color match to the substrate's painted surface. In many embodiments of the present invention the color of the substrate is in the same color family as the painted surface. For example, a tan painted surface would have a tan/brown colored substrate and a gray painted surface would have a gray colored substrate. In some embodiments a tan-gray substrate may be prepared to accommodate both a tan and gray color scheme. In various embodiments of the present invention, the color match of the resin color of the substrate to the painted surface is at least 50%. In other embodiments the color match is at least 70%. This can be challenging with recycled materials since many products molded from regrinds are normally black in color, mainly because of the carbon black content. To provide the desired substrate color one or more neutralizing colorants, color concentrates and/or color additives (e.g. white or light gray colorant) and/or one or more neutralizing resins (e.g. white or light gray polypropylene resin) may be added to the recycled black and/or colored resin to neutralize or reduce (e.g. lighten) the color. In various embodiments, a neutralizing resin (e.g. white polypropylene resin or light grey or tan polypropylene resin) may be added to the recycled resin to neutralize or reduce the color. In some embodiments about 1% to 25% (weight percent) neutralizing resin is added to a batch of recycled regrind and mixed thoroughly, thereby neutralizing the black or other color. Alternatively, the neutralizing or coloring of the color of the recycled resin may be performed by adding varying amounts of one or more neutralizing colorants, color concentrates, and/or color additives (e.g. white or light gray colorant) to the recycled resin. It is noted that the term colorant may be used in this disclosure to identify colorants, color concentrates and/or color additives. These colorants are typically let down as a percentage during the molding process. The amount of colorant added to a batch of recycled resin to neutralize the color may vary depending on the amount of carbon black present. However, in various embodiments 0.5 to 6% of a neutralizing colorant may be added to neutralize the color of the recycled resin. In other embodiments, 1 to 3% of a neutralizing colorant may be added to neutralize the color of the recycled resin. In yet other embodiments both a neutralizing colorant and neutralizing resin may be added to a batch. Subsequently or simultaneously, one or more other colorants, color concentrates and/or color additives (e.g. gray or tan) may be added to the recycled resin to provide the desired substrate color. The use of integral color in the substrate reduces the appearance of scratches or chips when the paint coating is abraded, scratched or chipped.

Additionally, in other embodiments, the exposed substrate surface of the landscaping or veneering products, may further include one or more designs (e.g. symbols, company names, logos, images) that may be positioned in the natural appearance texture and color (e.g. a company logo embedded in a stone color and texture). Also, in other embodiments of the present invention, the substrate may further include a design, such as the appearance of multiple bricks, stones, timbers or blocks. This allows for the installation of larger panels in a wall that appear to include a multitude of bricks, stones, blocks, timbers and the like.

In various embodiments, the texture may also be imprinted on substrate in a secondary process after formation of one or more components of the landscaping products (e.g. mass confinement cell, boulder, paver, edgers . . . ) or wall covering product by rolling a die that imprints the texture on the surface of the substrate, such as the polymeric front panel 224, fascia 254, 354 or other visible portion of the cell 210, 310 or the veneering panel, boulder, paver, edger or any other visible portion of these products.

Once the products are molded, the exposed substrates of the landscaping products, (e.g. front panel, fascia, end cap, cell cap, boulder, paver, edger . . . ) and veneering panels, may be colored and further textured utilizing a painting process. One such painting process that may be used with various embodiments of the present invention is a polymer adhesion painting process wherein a polymeric paint is adhered to the surface of the landscaping product or wall covering product. In some embodiments the polymer adhesion paint requires no pretreatment of the substrate surface. In other embodiments the polymer adhesion paint is administered to the substrate surface after the surface of the visible portion substrate, such as the front panel 224, 324, the fascia 264, 364, the end cap 364 or the cell cap 114, boulder, paver, edger, or veneering panel, has been flame treated or plasma or corona treated. Alternatively, adhesion promoters may be utilized in other embodiments of the present invention to promote adhesion of the polymer paints rather than flaming, plasma or corona treatment. However, it is noted that paint may not require and adhesion promoter or the adhesion promoter may be included in the base coat or may be the base coat applied to the substrate.

In various embodiments of the present invention the polymer adhering paint may be a solvent or water based paint. Examples of such paints are identified below. However, many of the embodiments of the present invention utilize a polymer adhering paint that has a very low gloss. For example, in embodiments of the present invention the gloss rating of the paint utilizing a 60° gloss meter is less than 5 and may be between 0 and 4. In various embodiments the gloss is between 1 and 3.

In one polymer adhesion painting method, the substrate is manufactured utilizing a process, such as injection molding, structural foam molding (e.g. low pressure multi-nozzle structural foam), injection molding using chemical and other foaming agents, rotomolding, thermoforming, extrusion or any other process. Next, all surfaces of the substrate intended to be painted may, if necessary, be flame treated, plasma or corona treated or treated with adhesion promoter prior to applying paint. The flame treating may be performed with any gas torch system, such as propane, acetylene and the like. Plasma treatment may also be performed by any device that forms a gas plasma that can be directed to the polymeric surface. The flame or plasma treated surface should be painted within 24 hours, optionally within 8 hours and further optionally within 5 hours. Once the surface has been flame, plasma, corona, or adhesion promoter treated, a polymer adhering paint, such as a polyurethane based paint mixed with a crosslinker or a waterbase paint is applied to the surface or surfaces of the panel 10. It is noted that the polymer adhering paint mixture should be applied shortly after mixing; in some embodiments almost immediately. It is also noted that a number of the paints identified below do not require the pretreatment of the substrate surface with flame, plasma or an adhesion promoter.

One example of the types of polymer paints that may be utilized with embodiments of the present invention is a two-component polyurethane that generally includes a mix ratio of three to five parts colored paint with one to two parts crosslinker (e.g. XL-003 crosslinker or an isocynate). Two examples of two such polyurethane based paints are as follows:

### Example 1

HIGH SOLIDS ALLPHATIC POLYURETHANE
120 Series
DESCRIPTION
High Solids 3.5 V.O.C. two component polyurethane for metal, plastic,
and interior wood. It is used for industrial and automotive applica-
tions. This system has excellent chemical and stain resistance. It has
shown excellent adhesion to many substrates with good mar and abrasion
resistance and it has 2-3H hardness.
CHARACTERISTICS

| | |
|---|---|
| Density - lbs/gal: | 7.95-13.0 |
| Solids, wt. %: | 51-70 |
| Solids, volume: | 42.9-60 |
| Viscosity: | 35-42 Sec. |
| Flash Point ° F. | 80 |
| Application Method: | Conventional of HVLP |
| Reduction for Application: | 5-base; 1-XL009; 1-acetone |
| | 6-base; 1-XL003; 1-20LT161 |
| Pot Life: | 3-HRS @ 70° F. |
| Cure Schedule: | 30 min @ 180° F. |
| Gloss 60°: | Flat to 96 |
| VOC as supplied - lbs/gallon: | 3.0-3.6 |
| VOC as applied - lbs/gallon: | 2.9-3.5 |

### Example 2

MEDIUM SOLIDS ALLPHATIC POLYURETHANE
121 Series
DESCRIPTION
The 121 Series is a medium solids, low temperature cure two component
polyurethane for use on metal and plastic. It is used for industrial
and automotive applications. This system has excellent chemical, stain,
and water soak resistance. It has good adhesion to many substrates with
good mar and abrasion resistance and it has 2H hardness.
CHARACTERISTICS

| | |
|---|---|
| Density - lbs/gal: | 7.92-11.0 |
| Solids, wt. %: | 45-67 |
| Solids, volume: | 37-48 |
| Viscosity: | 45 sec Zahn#2 |
| Flash Point ° F. | 78 |
| Application Method: | HVLP; Conv. |
| Reduction for Application: | 4-base; 1-XL009 |
| | 5-base; 1-XL003 |
| Pot Life: | 2 hrs @ 70° F. |
| Cure Schedule: | 35 min @ 160° F., Air Dry |
| | tack free 40 min |
| Gloss 60°: | Flat to 96 |
| VOC as supplied - lbs/gallon: | 3.6-4.3 |
| VOC as applied - lbs/gallon: | 3.37-4.0 |

Both polymer adhesion paints of Examples 1 and 2 are manufactured and distributed by:
PRIME COATINGS
1002 Hickory Street
Pewaukee, WI 53072
www.primecoatings.net
Telephone: (262) 691-1930

Alternative polymer adhesion paints that may be utilized with the present invention include solvent based paints and waterborne paints produced for low surface energy polymers, such as polypropylene and polyethylene. Examples of such solvent and water based paints that may be utilized with the cells of the present invention include, but are not limited to the polyurethane based paints (e.g. 2K High Solids Urethane Base Coat products) produced by Redspot Paint & Varnish Company, Inc. of Evansville, Ind. or the polyurethane, waterborne or powder based paints, such as Polane® Polyurethane Systems, Polane® or Kem® AquaWaterborne Systems, Powdura® Powder Coating Systems, all produced by Sherwin Williams. Two examples of waterborne paints that do not require flame, plasma or corona treatment of the panel surface prior to application are as follows:

### Example 3

NuBond ™
DESCRIPTION
The NuBond ™ (ID Code: AWOR-1208) is a medium solids, low VOC
waterborne coating for use on metal and plastic. It is used for industrial
and automotive applications. This system has excellent chemical, stain,
and water soak resistance. It has good adhesion to many substrates with
good mar and abrasion resistance.

| | |
|---|---|
| Code | AWOR-1208 |
| Description | One-Component Waterborne Coating |
| | for TPO |
| Name of Product | Stone White |
| Color No. | N/A |
| Packaged Viscosity | 30-40 seconds #3 Zahn (EZ) Cup |
| Weight/Gallon | 9.36 ± 0.50 |
| % Weight Solids | 43.34 ± 2.00 |
| % Volume Solids | 34.98 ± 2.00 |
| % Gloss | 2.0-2.2 on a 60° glossmeter |
| Package V.O.C. | 1.81 ± 0.15 lb/gal (minus exempt) |
| | 0.83 ± 0.15 lb/gal (including exempt) |
| Method of Application | HVLP or Conventional Spray |
| Application Viscosity | As is |
| Reduction | Up to 5% with water |
| Thinner | Water |
| Substrate | TPO and/or Polypropylene |
| Clean-up Thinner | Water until dry/switch to MEK |
| Curing Conditions | 30 minutes @ 200° F. |
| Flash Time | 3-5 minutes |
| Dry Film Thickness | 1.0 ± 0.2 mils |

### Example 4

NuBond ™
DESCRIPTION
The NuBond ™ (ID Code: AWOR-2447) is a medium solids, low VOC
waterborne coating for use on metal and plastic. It is used for industrial
and automotive applications. This system has excellent chemical, stain,
and water soak resistance. It has good adhesion to many substrates
with good mar and abrasion resistance.

| | |
|---|---|
| Code | AWOR-2447 |
| Description | One-Component Waterborne Coating |
| | for TPO |
| Name of Product | Stone Gray |
| Color No. | N/A |
| Packaged Viscosity | 30-40 seconds #3 Zahn (EZ) Cup |
| Weight/Gallon | 9.25 ± 0.50 |
| % Weight Solids | 42.60 ± 2.00 |
| % Volume Solids | 34.85 ± 2.00 |
| % Gloss | 2.0-2.2 on a 60° glossmeter |
| Package V.O.C. | 1.85 ± 0.15 lb/gal (minus exempt) |
| | 0.85 ± 0.15 lb/gal (including exempt) |
| Method of Application | HVLP or Conventional Spray |
| Application Viscosity | As is |
| Reduction | Up to 5% with water |
| Thinner | Water |
| Substrate | TPO and/or Polypropylene |
| Clean-up Thinner | Water until dry/switch to MEK |
| Curing Conditions | 30 minutes @ 200° F. |
| Flash Time | 3-5 minutes |
| Dry Film Thickness | 1.0 ± 0.2 mils |

Both polymer adhesion paints of Examples 3 and 4 are manufactured and distributed by:
United Paint, Inc.
24671 Telegraph Road
Southfield, MI 48033-3035
Tel: 248.353.3035
Fax: 248.353.4865
www.unitedpaint.com

The polymer adhering paints may further include one or more additives to provide additional beneficial characteristics. For example, additional texture may be applied to the surface of a substrate by including additives to the paint in fine, medium or course particulate form. Such particulate additives may be selected from any suitable texture additives such as mica, sand, perlite, pumice, silica, metal, acrylic or glass beads and fibers, or any other paint texture additive. The paint additives may be included in the paint or applied in the painting process. For example, paint textures such as mica, sand, pumice and the like may be dropped, propelled (e.g. propelled toward the surface using a device, such as a sandblaster) or sifted (e.g. sprinkled onto the surface by gravity or using a sieve) onto the surface of the substrate while simultaneously applying the base coat and/or secondary coat(s) of paint. Such a process disperses and entraps the texture in the coating, thereby giving a fine, medium or course textured surface. Alternatively, the texture may be applied after the base coat and/or secondary coat is applied, thereby providing a more gritty appearance, texture and feel. This may be done while the paint is still wet or partially wet thereby adhering the texture to the surface during drying.

The polymer adhesion paints may be applied in any manner known in the art including, but not limited to, spraying, dipping, brushing, sponging and any other paint application method. In various embodiments polymer adhesion paint is applied by spraying. Generally, less than 10 mils of paint are applied to the surface intended to be painted. In other embodiments less than 5 mils of paint is applied and in other embodiments less than 3 mils of paint is applied to the surface intended to be painted. In various examples, approximately 0.2 to 3 mils or 0.5 to 2 mils dry film thickness of base color was applied to the entire surface of panels. Once the base paint has been applied, one or more secondary colors may optionally be applied to the wet or dry base coat as desired. Such secondary colors may be applied in similar ways as the base paint, such as spraying, dipping, brushing, sponging and any other spray technique known in the art. It is also noted that a primer layer may be applied to the substrate surface prior to applying the paints described herein. For example, a coating of binel, parylene or another primer coat may be applied to the surface prior to applying the paint to promote optimum adhesion.

Once the paint has been applied to the desired surface of the substrate or other visible portion of the product, the product is then cured. In various embodiments of the present invention, the product is oven cured following painting at a temperature of 225° F. and less (e.g. 175° F. to 220° F.); in other embodiments 205° F. and less (e.g. 160° F. to 200° F.); and in still other embodiments 180° F. and less (e.g. 100° F. to 150° F.). In various embodiments the paint, is cured at the above mentioned temperatures for a period of 2 minutes to 4 hours; in other embodiments 5 minutes to 2 hours and in still other embodiments 10 minutes to 30 minutes. The product is then allowed to air dry. Once air dried, the landscaping or wall covering products are ready for installation. It is noted that the curing process may be performed at room temperatures, but the curing time usually will be lengthened accordingly.

An example of one method for coating the substrates or other visible portions of the landscaping or wall covering products of the present invention is by utilizing a line manufacturing system. For example a series of substrate fixtures that adequately hold and position the substrates can be adjoined to a paint line to transport the substrates through a coating system. The paint line may be any system known in the art, including a chain on edge system or an overhead conveyor line system.

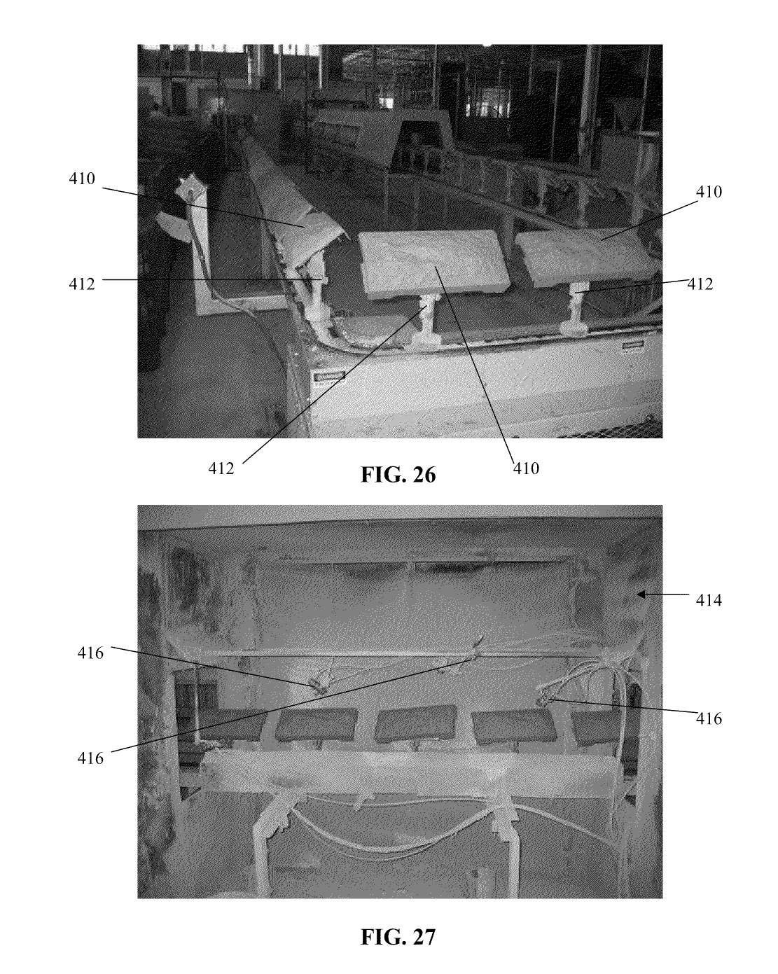

FIG. 26 depicts one embodiment of a paint line (i.e. a chain on edge system) that may be used in the painting of the substrates of the present invention. When using the paint line system depicted in FIG. 26, the substrates 410 are positioned on a substrate fixture 412, which have been secured to a chain in the chain on edge line. The substrates are moved through a first paint booth 414, as depicted in FIG. 27 where one or more spray guns 416 apply a base coat of approximately 1-3 mils to the substrate 410. An example of spray guns that may be used to coat the substrates of the present invention are Dux spray guns produced by Dux Area, Inc. of Seattle, Wash.

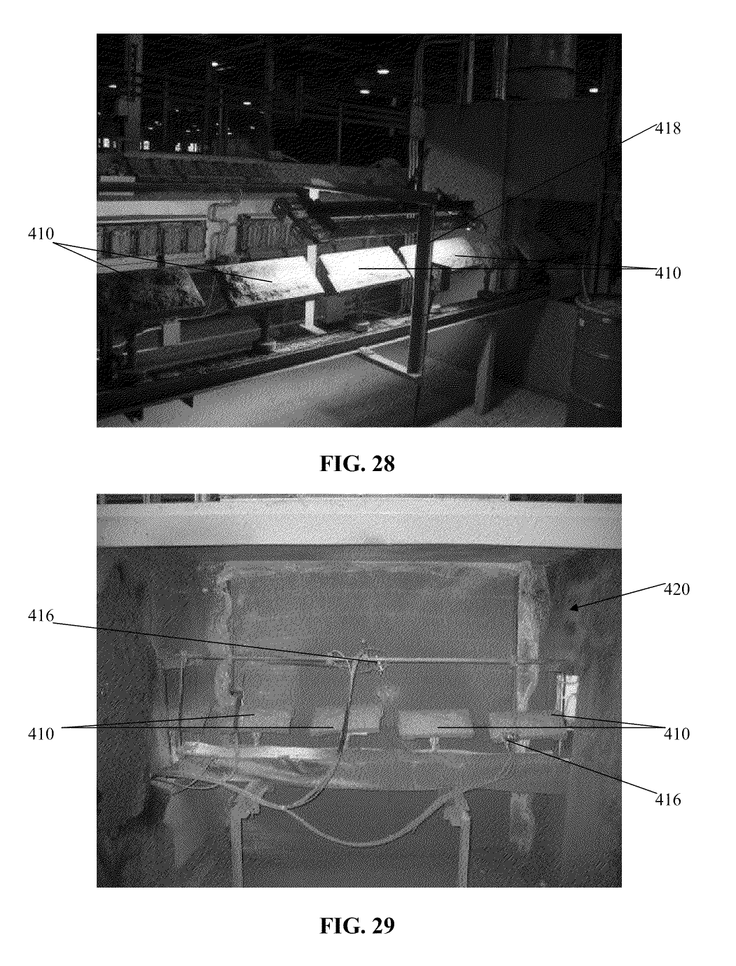

Next, the substrates exit the first paint booth 414 and are optionally exposed to a drying mechanism 418, such as a IR heater, UV heater or forced dry/heated air, for a short period of time to partially dry the paint before application of one or more secondary coatings. FIG. 28 depicts one embodiment of a drying mechanism (a U.V. lamp) that may be used in the described method of the present invention.

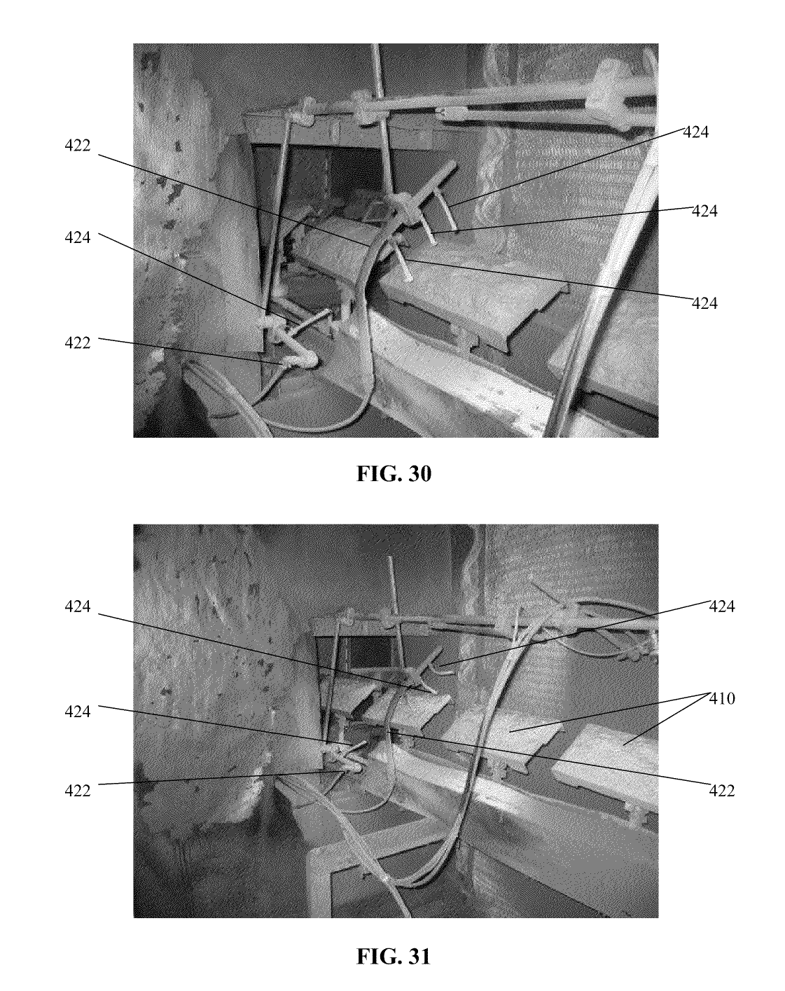

Upon completion of the partial drying of the substrates 410, the substrates 410 are transported by the chain on edge system or conveyor system through one or more second paint booths 420 wherein one or more secondary coatings/paints are applied with paint guns 416 to the substrate surface to provide multiple colors to the surface of the substrate. While still wet, the base and/or secondary coatings or paints are next moved or manipulated with a paint movement device to provide the desired highlighting, streaking, shadowing, and blotching found in natural stone, rock, brick or wood. In various embodiments, the manipulation of the secondary coatings are done with compressed air or sprayed solvent (e.g. water, paint thinner . . . ) that is randomly directed toward the surface of the substrate with spray guns, hoses, air knives or flexible tubing. FIGS. 30 and 31 depict one embodiment of the present invention wherein compressed air is passed through one or more lines 422 and through flexible tubing 424 (e.g. neoprene tubes, fluoroelastomer tubes, polyurethane tubes, polyisoprene tubes, silicon tubes, rubber tubes, flexible rubber or silicon tubes . . . ) at a pressure of approximately 10-60 psi (e.g. 35-45 psi) to move or manipulate the wet paint on the surface of the substrate 410. The tubes 424 are flexible so as to freely move as compressed air is forced through them. The tubes are positioned above the substrate at a distance that provides the desired movement of the secondary coating. For example, the tubing may be positioned in some embodiments between 2-12 inches (e.g. 2-6 in.) above the substrate to provide the desired appearance. It is noted that the distance between the tubing and the substrate may vary depending on the desired appearance and the pressure of the compressed air or solvent applied to the substrate surface. The tubes may be weighted to control movement by placing plastic tubing or other weighting devices at the end of the flexible tubes or into the lumen of the flexible tubes. In one embodiment, compressed air manipulation of the secondary coating(s) has been found to provide an appearance that resembles cut stone or rock. Alternative, methods that may be used to manipulate or move the secondary coating include passing over the substrate surface brushes, sponges, rags and the like.

In various embodiments, once the secondary coating has been manipulated, the base coat and secondary coating are allowed to partially dry by transportation of the substrates through a short flash tunnel. In various embodiments, the flash tunnel is no more than 25-100 ft (e.g. 50-80 ft). Vacuum may optionally used in the flash tunnel if desired.

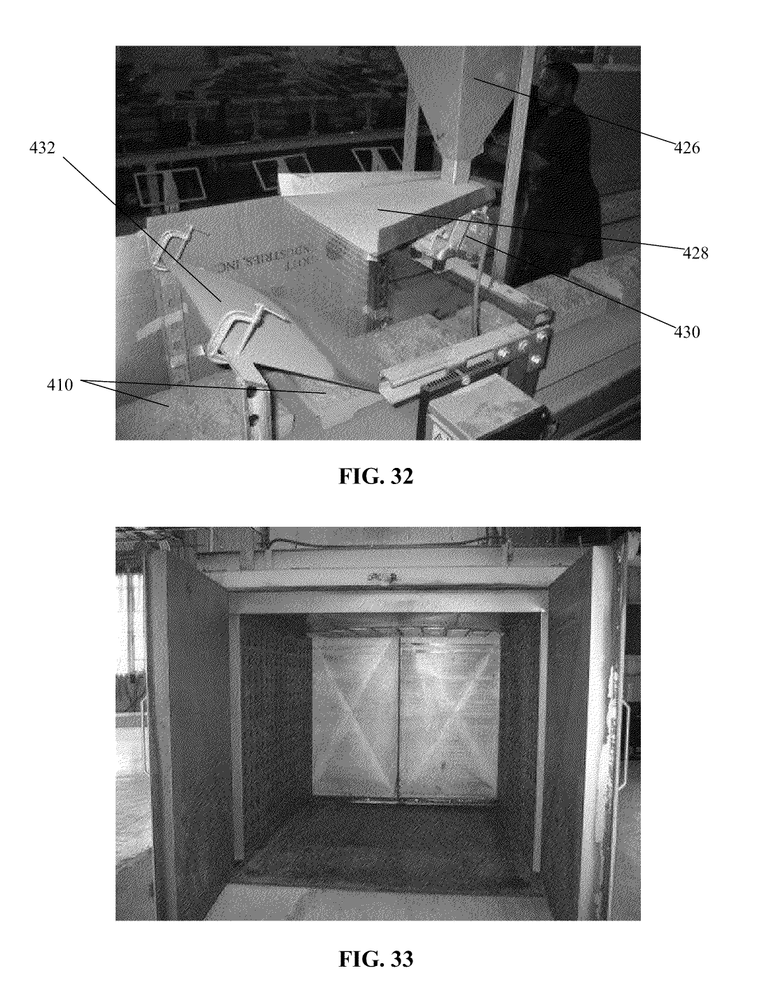

In some embodiments of the present invention, once the substrates 410 have received the secondary coating, finished the coating or paint manipulation step, or have exited the flash tunnel, a texture material (e.g. sand, mica . . . ) may be added to the partially dried surface by a texture applicator. As depicted in FIG. 32, in one embodiment of the present invention, a texture is applied to the surface of a substrate by a texture applicator by dropping the texture from a hopper 426 onto a first slanted platform 428. The first platform 428 is constantly shaken with a vibrator 430 to homogenously distribute the texture and move the texture down the slated surface of the platform. In this embodiment, the texture is dropped from the first platform 428 to a second slanted platform 432 to further distribute the texture and provide a proper vehicle to homogenously distribute the texture to the surface of the substrate(s) 410. The force from the drop of the texture imbeds the texture into the partially dried coating, thereby securing it to the surface of the substrate 410. It is noted that other sieve or texture spraying techniques may be used to properly administer the texture to the surface of the substrates. Once properly coated and textured, the substrates 410 are placed into an oven to further cure the paint and secure the texture. In various embodiments of the present invention, the substrates are placed into a convection oven at a temperature between 160° and 210° F. for a period of 10 to 30 minutes. However, the types of coating will dictate the proper cure temperatures and times for curing. An example of a convection oven used in the described method is depicted in FIG. 32. Upon leaving the oven, the substrate may cure for an additional period of 1 to 72 hours at ambient air temperature before use is recommended.

While the invention has been illustrated and described in detail in the drawings and foregoing description, such an illustration and description is to be considered as exemplary and not restrictive in character, it being understood that only the preferred embodiments have been shown and described and that all changes and modifications that come within the spirit of the invention are desired to be protected.

1. A wood, brick, cut stone or rock imaged substrate comprising:
a substrate including one or more composite or polymeric materials and having a front surface including texture and relief that is obtained by imaging a wood, brick, stone or rock surface;
a base coat comprising one or more polymer adhesion paints that are applied over the front surface of the substrate;
one or more secondary coats comprising one or more polymer adhesion paints that are applied over the base coat and subsequently moved or manipulated on the base coat with a paint movement device to facilitate highlighting, blotching, streaking and/or shadowing to produce a wood, brick, stone or rock appearance; and
one or more texture materials added or applied to the base coat or secondary coats.

2. The wood, brick, stone or rock imaged substrate of claim 1 wherein the composite or polymeric material is selected from the group consisting of polyethylene, polypropylene, polyurethane, Acrylonitrile-butadiene-styrene (ABS), Poly(butylene terephthalate) (PBT), Poly(cyclohexanedimethylene terephthalate) (PCT), styrene-acrylonitrile copolymers (SAN), polystyrene, polycarbonate, polyester, thermosets and combinations and copolymers thereof.

3. The wood, brick, stone or rock imaged substrate of claim 1 wherein the secondary coats are moved or manipulated by applying compressed air or sprayed solvent to the front surface of the substrate.

4. The wood, brick, stone or rock imaged substrate of claim 1 wherein the imaging is performed by casting or digital scanning the wood, brick, stone or rock surface.

5. The wood, brick, stone or rock imaged substrate of claim 1 wherein the composite or polymeric materials included in the substrate include recycled plastic resin.

6. The wood, brick, stone or rock imaged substrate of claim 5 wherein the recycled plastic resin is colored to a color match compared to the combined base and secondary coats of paint to at least a 60% match.

7. The wood, brick, stone or rock imaged substrate of claim 1, wherein the substrate is formed into or included in a landscaping product selected from the group consisting of mass confinement cells, boulders, pavers and edgers.

8. The wood, brick, stone or rock imaged substrate of claim 1, wherein the substrate is formed into or included in a wall covering product.

9. A mass confinement cell comprising:
A frame including a front panel and two side panels operably adjoined to the front panel, the front panel either including a front surface or supporting a fascia that has been molded and/or fabricated to include the texture and relief of a wood, brick, stone or rock that is obtained by imaging a wood, brick, stone or rock surface;
a base coat comprising one or more polymer adhesion paints that are applied over the front surface of the front panel or the fascia;
one or more secondary coats comprising one or more polymer adhesion paints that are applied over the base coat and subsequently moved or manipulated on the base coat with a paint movement device to facilitate highlighting, blotching, streaking and/or shadowing to produce a wood, brick, stone or rock appearance;
one or more texture materials added or applied to the base coat or secondary coats; and
a load cell operably adjoined to the frame with one or more cell fasteners to form a chamber.

10. The mass confinement cell of claim 9 wherein the cell further includes one or more fill materials placed into the chamber of the mass confinement cell.

11. The mass confinement cell of claim 9 wherein the frame, load cell and fascia include one or more deterioration resistant composite or polymeric materials.

12. The mass confinement cell of claim 11 wherein composite or polymeric materials are selected from the group consisting of polyethylene, polypropylene, polyurethane, Acrylonitrile-butadiene-styrene (ABS), Polyethylene terephthalate (PET), polycarbonate, Poly(butylene terephthalate) (PBT), Poly(cyclohexanedimethylene terephthalate) (PCT), styrene-acrylonitrile copolymers (SAN), polystyrene and combinations thereof.

13. The mass confinement cell of claim 11, wherein the composite or polymeric materials includes one or more colors, filler materials and/or additives.

14. The mass confinement cell of claim 9 wherein the frame and/or load cell include one or more cell fasteners positioned at different locations to accommodate more than one set-back position.

15. The mass confinement cell of claim 9, wherein the mass confinement cell further includes one or more peg extensions for anchoring the unit to adjacent units.

16. The mass confinement cell of claim 9, wherein the front panel and side panels are adjoined with living hinges.

17. The mass confinement cell of claim 9, including a partial top panel that extends from a front edge of the front panel back a length no more than 40% of the width of the cell.

18. A polymeric veneering panel comprising:
one or more composite or polymeric materials and having a front surface including one or more stone or rock images having texture and relief that is obtained by imaging one or more wood, brick, stones or rocks;
a base coat comprising one or more polymer adhesion paints that are applied over the front surface of the veneering panel;
one or more secondary coats comprising one or more polymer adhesion paints that are applied over the base coat and subsequently moved or manipulated on the base coat with a paint movement device to facilitate highlighting, blotching, streaking and/or shadowing to produce a wood, brick, stone or rock appearance;
one or more texture materials added or applied to the base coat or secondary coats;
a hollowed back surface; and
one or more attachment platforms adapted to accept one or more fastening devices for adjoining the panel to a substrate surface.

19. The polymeric veneering panel of claim 18 further including at least three or more fields that extend partially along the perimeter of the panel and further extend through the interior of the panel, each of the fields being broken by at least one wood, brick, stone or rock image.

20. The polymeric veneering panel of claim 18 wherein the composite or polymeric material is selected from the group consisting of polyethylene, polypropylene, polyurethane, Acrylonitrile-butadiene-styrene (ABS), Poly(butylene terephthalate) (PBT), Poly(cyclohexanedimethylene terephthalate) (PCT), styrene-acrylonitrile copolymers (SAN), polystyrene, polycarbonate, polyester, thermosets and combinations and copolymers thereof.

21. The polymeric veneering panel of claim 18 wherein the one or more fasteners are selected from the group consisting of two sided tapes, sealants, screws, nails, rivets, and clipping devices.

22. The polymeric veneering panel of claim 18 wherein the front surface displays texture and relief from imaging a rock or stone surface by casting or digital scanning the wood, brick, rock or stone surface.

23. The polymeric veneering panel of claim 18 further including one or more tongues and one or more grooves for securing each panel to adjacent panels.

24. The polymeric veneering panel of claim 18 wherein the panel is shaped in a Z-unit or T-unit configuration.
